(19) United States
(12) Patent Application Publication
(10) Pub. No.: US 2026/0135599 A1
(43) Pub. Date: May 14, 2026

(54) APPARATUS AND METHOD FOR SUPPORTING BEAMFORMING OF FRONTHAUL TRANSMISSION IN WIRELESS COMMUNICATION SYSTEM

(71) Applicant: SAMSUNG ELECTRONICS CO., LTD., Suwon-si (KR)

(72) Inventors: Kyoung HEO, Suwon-si (KR); Wooyeon Kim, Suwon-si (KR); Jiung Woo, Suwon-si (KR); Sungwon Ko, Suwon-si (KR)

(73) Assignee: SAMSUNG ELECTRONICS CO., LTD., Suwon-si (KR)

(21) Appl. No.: 19/445,165

(22) Filed: Jan. 9, 2026

Related U.S. Application Data
(63) Continuation of application No. PCT/KR2024/002423, filed on Feb. 26, 2024.

(30) Foreign Application Priority Data
Jul. 11, 2023 (KR) 10-2023-0089929
Jul. 26, 2023 (KR) 10-2023-0097635

(51) Int. Cl. H04B 7/06; H04B 7/08; H04L 27/26

(52) U.S. Cl. CPC H04B 7/0634; H04B 7/0617; H04B 7/086; H04L 27/2628

(57) ABSTRACT

The present disclosure relates to a 5G or 6G communication system for supporting a higher data transmission rate. A method performed by a radio unit (RU) in a wireless communication system, according to various embodiments of the present disclosure, may include the steps of: acquiring one or more pieces of multiplexed (MUX) layer data on the basis of at least one piece of layer data; acquiring at least one piece of antenna data in which a beamforming weight is applied to the one or more pieces of multiplexed layer data; performing an inverse fast Fourier transform (IFFT) conversion on the at least one piece of antenna data; and performing IFFT processing on the at least one piece of antenna data on which IFFT conversion has been performed.

### CROSS-REFERENCE TO RELATED APPLICATIONS

This application is a Continuation Application of International Application PCT/KR2024/002423 filed on Feb. 26, 2024, which claims priority to Korean Patent Application No. 10-2023-0089929, filed on Jul. 11, 2023, and Korean Patent Application No. 10-2023-0097635, filed on Jul. 26, 2023, the disclosures of which are incorporated herein in their entireties by reference.

### FIELD

The disclosure generally relates to a wireless communication system and, more specifically, to an apparatus and a method for supporting beamforming for fronthaul transmission in a wireless communication system.

### BACKGROUND

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced mobile broadband (eMBB), ultra-reliable low-latency communications (URLLC), and massive machine-type communications (mMTC), there has been ongoing standardization regarding beamforming and massive multiple-input multiple-output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is user equipment-satellite (UE-satellite) direct communication for securing coverage in an area in which communication with terrestrial networks is unavailable, and positioning.

Moreover, there has been ongoing standardization in wireless interface architecture or protocol fields regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channels (2-step RACH) for simplifying random access procedures. There also has been ongoing standardization in system architecture/service fields regarding a 5G baseline architecture (for example, service based architecture or service based interface) for combining network functions virtualization (NFV) and software-defined networking (SDN) technologies, and mobile ddge computing (MEC) for receiving services based on UE positions.

If such 5G mobile communication systems are commercialized, connected devices that have been exponentially increasing will be connected to communication networks. It is accordingly expected that enhanced functions and performances of 5G mobile communication systems and integrated operations of connected devices will be necessary. To this end, new research is scheduled in connection with eXtended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for securing coverage in terahertz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

As transmission capacity increases in wireless communication systems, a function split for functionally separating a base station is being applied. According to the function split, the base station may be divided into a distributed unit (DU) and a radio unit (RU), and a fronthaul for communication between the DU and the RU is defined. Accordingly, a structure and a technology for supporting beamforming in fronthaul transmission are required.

### SUMMARY

Based on the above-described discussions, the disclosure provides a method and an apparatus for supporting beamforming and inverse fast Fourier transform (IFFT) conversion performed in an RU.

In addition, the disclosure provides a method and an apparatus for effectively optimizing a memory for precoding in a wireless communication system.

According to various embodiments of the disclosure, in a wireless communication system, a method performed by a radio unit (RU) may include acquiring one or more pieces of multiplexed (MUX) layer data based on at least one layer data, acquiring at least one piece of antenna data by applying beamforming weights to the one or more pieces of multiplexed layer data, performing an inverse fast Fourier transform (IFFT) conversion on the at least one piece of antenna data, and performing IFFT processing on the at least one piece of antenna data on which the IFFT conversion has been performed.

According to various embodiments of the disclosure, a radio unit may include a transceiver and a controller coupled to the transceiver, and the controller may be configured to acquire, based on at least one piece of layer data, one or more pieces of multiplexed layer data, acquire at least one piece of antenna data by applying beamforming weights to the one or more pieces of multiplexed layer data, perform an inverse fast Fourier transform conversion on the at least one piece of antenna data, and perform IFFT processing on the at least one piece of antenna data on which the IFFT conversion has been performed. A method and an apparatus according to various embodiments of the disclosure perform an inverse fast Fourier transform conversion at a front-end side of an IFFT block after application and computation of a beamforming weight, thereby enabling effective operation of memory reduction.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1A illustrates a wireless communication system according to various embodiments of the disclosure.

FIG. 1B illustrates an example of a fronthaul structure based on a function split of a base station according to various embodiments of the disclosure.

FIG. 2 illustrates a structure of a distributed unit (DU) according to various embodiments of the disclosure.

FIG. 3 illustrates a structure of a radio unit (RU) according to various embodiments of the disclosure.

FIG. 4 illustrates an example of a function split according to various embodiments of the disclosure.

FIG. 5 illustrates an example of a connection between a DU and an RU according to various embodiments of the disclosure.

FIG. 6 illustrates a structure of a downlink chain block of an RU according to various embodiments of the disclosure.

FIG. 7 illustrates an example of a frequency spectrum for inverse fast Fourier transform (IFFT) conversion according to various embodiments of the disclosure.

FIG. 8 illustrates an example of timing for a path multiplexer (MUX) according to various embodiments of the disclosure.

FIG. 9A illustrates a detailed structure of a downlink chain block including an IFFT conversion position according to various embodiments of the disclosure.

FIG. 9B illustrates a detailed structure of a downlink chain block including a memory for precoding and beamforming according to various embodiments of the disclosure.

FIGS. 10A and 10B illustrate an example of timing regarding precoding and beamforming according to various embodiments of the disclosure.

FIGS. 11A and 11B illustrate a downlink chain block including a beamforming block and a structure of a beamforming block for performing beamforming and IFFT conversion according to various embodiments of the disclosure.

FIG. 12 illustrates another detailed structure of a downlink chain block including a memory for precoding and beamforming according to various embodiments of the disclosure.

FIG. 13 illustrates another example of timing regarding precoding and beamforming according to various embodiments of the disclosure.

FIG. 14 illustrates a detailed structure of a block for IFFT conversion according to various embodiments of the disclosure.

FIGS. 15A and 15B illustrate an example of timing regarding IFFT conversion according to various embodiments of the disclosure.

FIG. 16 illustrates examples of improved usage amounts and reduction rates of a memory and a complex multiplier according to various embodiments of the disclosure.

### DETAILED DESCRIPTION

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the following description, terms referring to signals (e.g., message, information, preamble, signal, signaling, sequence, and stream), terms referring to resources (e.g., symbol, slot, subframe, radio frame, subcarrier, resource element (RE), resource block (RB), physical resource block (PRB), bandwidth part (BWP), and occasion), terms referring to arithmetic operation states (e.g., step, operation, and procedure), terms referring to data (e.g., packet, user stream, information, bit, symbol, and codeword), terms referring to channels, terms referring to control information (e.g., downlink control information (DCI), medium access control control element (MAC CE), and radio resource control (RRC) signaling), terms referring to network entities, terms referring to device elements, and the like are illustratively used for the sake of descriptive convenience. Therefore, the disclosure is not limited by the terms as described below, and other terms referring to subjects having equivalent technical meanings may be used.

Furthermore, as used herein, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, various embodiments of the disclosure will be described using terms employed in some communication standards (e.g., the 3rd generation partnership project (3GPP), the extensible radio access network (xRAN), and the open-radio access network (0-RAN)), but they are for illustrative purposes only. Various embodiments of the disclosure may also be easily applied to other communication systems through modifications.

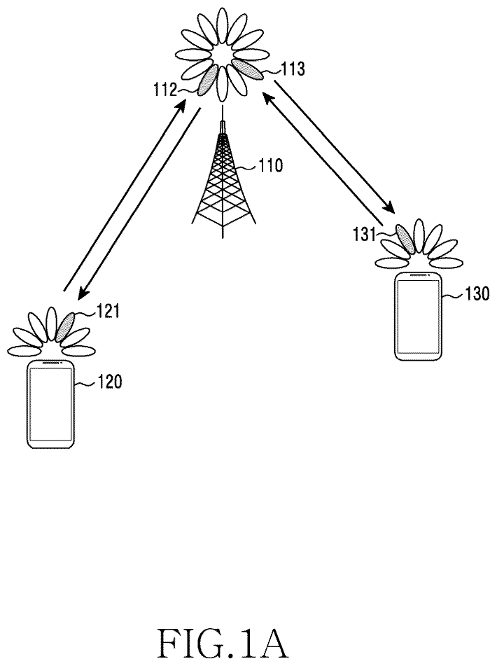

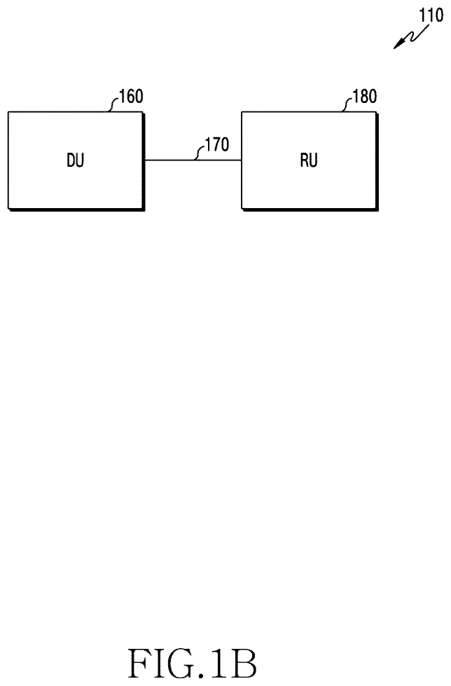

FIG. 1A illustrates a wireless communication system according to various embodiments of the disclosure. FIG. 1A illustrates an example of a base station 110, a UE 120, and a UE 130 as a part of nodes that use radio channels in a wireless communication system. Although FIG. 1 illustrates only one base station, other base stations identical or similar to the base station 110 may be further included.

The base station 110 is a network infrastructure that provides the UEs 120 and 130 with radio access. The base station 110 has coverage which is defined as a certain geographical area, based on a distance over which a signal can be transmitted. In addition to the term “base station”, the base station 110 may be referred to as an “access point (AP)”, an “eNodeB (eNB)”, a “5th generation node (5G node)”, a “next generation nodeB (gNB)”, a “wireless point”, a “transmission/reception point (TRP)”, or other terms having equivalent technical meanings.

Each of the UE 120 and the UE 130 is a device used by a user and performs communication with the base station 110 through a wireless channel. A link directed from the base station 110 to the UE 120 or the UE 130 is referred to as a downlink (DL), and a link directed from the UE 120 or the UE 130 to the base station 110 is referred to as an uplink (UL). In addition, the UE 120 and the UE 130 may communicate with each other through a radio channel. A link between the UE 120 and the UE 130 (device-to-device link (D2D)) is referred to as a sidelink, which may be used interchangeably with “PC5 interface”. In some cases, at least one of the UE 120 and the UE 130 may be operated without a user's involvement. That is, at least one of the UE 120 and the UE 130 may be a device performing machine-type communication (MTC), and may not be carried by a user. In addition to the term “user equipment (UE)”, each of the UE 120 and the UE 130 may also be referred to as “terminal”, a “mobile station”, a “subscriber station”, a “remote terminal”, a “wireless terminal”, a “user device”, or other terms having equivalent technical meanings.

The base station 110, the UE 120, and the UE 130 may perform beamforming. The base station and the UEs may transmit and receive radio signals in a relatively low frequency band (for example, frequency range 1 (FR1) of new radio (NR). In addition, base station and the UEs may transmit and receive radio signals in a relatively high frequency band (for example, FR2 of NR, mmWave band (for example, 28 GHz, 30 GHz, 38 GHz, 60 GHz)). In some embodiments, the base station 110 may communicate with the UE 120 within a frequency range corresponding to FR1. In some embodiments, the base station 110 may communicate with the UE 120 within a frequency range corresponding to FR2. In this regard, in order to improve a channel gain, the base station 110, the UE 120, and the UE 130 may perform beamforming. The beamforming may include transmission beamforming and reception beamforming. That is, the base station 110, the UE 120, and the UE 130 may apply directivity to transmission signals or reception signals. To this end, the base station 110 and the UEs 120 and 130 may select serving beams 112, 113, 121, and 131 via a beam search procedure or a beam management procedure. After the serving beams 112, 113, 121, and 131 are selected, subsequent communication may be performed through resources having a quasi co-located (QCL) relationship with resources used to transmit the serving beams 112, 113, 121, and 131.

If large-scale characteristics of a channel, via which a symbol on a first antenna port has been transferred, can be inferred from a channel via which a symbol on a second antenna port has been transferred, it may be evaluated that the first antenna port and the second antenna port are in a QCL relationship. For example, the large-scale characteristics may include at least one of a delay spread, a Doppler spread, a Doppler shift, average gain, an average delay, and a spatial receiver parameter.

Although the base station and the UEs are all illustrated in FIG. 1A as performing beamforming, various embodiments of the disclosure are not necessarily limited thereto. In some embodiments, the UEs may or may not perform beamforming. In addition, the base station may or may not perform beamforming. That is, only one of the base station and the UEs may perform beamforming, or none of the base station and the UEs may perform beamforming.

In the disclosure, a beam refers to a spatial flow of signals through a radio channel, and is formed by one or more antennas (or antenna elements), and such a process of formation may be referred to as beamforming. Beamforming may include analog beamforming and digital beamforming (for example, precoding). Examples of a reference signal transmitted based on beamforming may include a demodulation-reference signal (DM-RS), a channel state information-reference signal (CSI-RS), a synchronization signal/physical broadcast channel (SS/PBCH), and a sounding reference signal (SRS). In addition, as a configuration regarding each reference signal, an information element (IE) such as a CSI-RS resource or SRS-resource may be used, and such a configuration may include information associated with a beam. The information associated with a beam may indicate whether the corresponding configuration (for example, CSI-RS resource) uses the same spatial domain filter with another configuration (for example, another CSI-RS resource in the same CSI-RS resource set) or uses a different spatial domain filter, or with which reference signal the corresponding configuration is quasi-co-located (QCLed), or in which type (for example, QCL type A, B, C, or D) if QCLed.

Conventionally, in a communication system having a relatively large cell radius of base stations, each base station is installed such that each base station includes functions of a digital processing unit (or distributed unit (DU)) and a radio frequency (RF) processing unit (or a radio unit (RU)). However, 4th generation (4G) and/or later communication systems use high frequency bands, and the cell radius of base station are reduced, thereby increasing the number of base stations for covering a specific region, and increasing the burden on operators who need to install more base stations. In order to minimize the costs for installing base stations, a structure has been proposed in which the DU and RU of a base station are split such that one or more RUs are connected to one DU through a wired network and one or more RUs distributed geographically are deployed to cover a specific area. Hereinafter, examples in which a base station is disposed and expanded according to various embodiments of the disclosure will be described with reference to FIG. 1B.

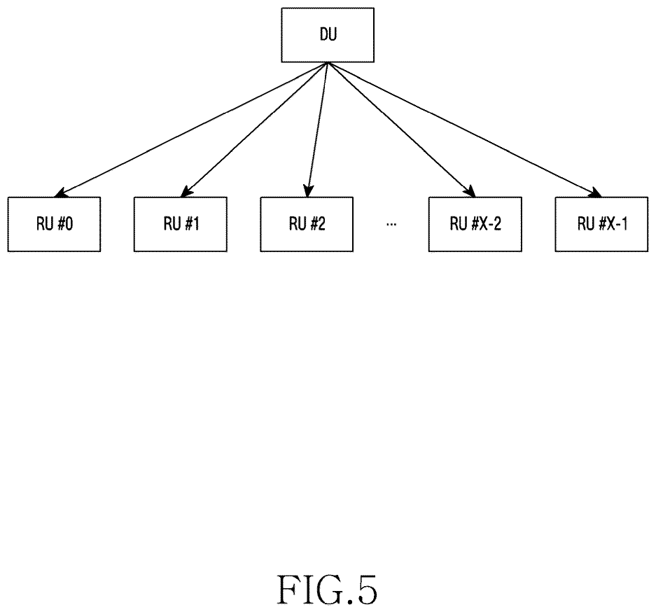

FIG. 1B illustrates an example of a fronthaul structure based on a functional split of a base station according to various embodiments of the disclosure. The fronthaul refers to a part between entities between a wireless LAN and a base station, unlike a backhaul between a base station and a core network. Although a DU and a RU are illustrated in FIG. 1B, the DU and RU may, without being limited thereto, refer to an O-DU and O-RU, respectively, which are terms based on O-RAN specifications, according to various embodiments of the disclosure, and the above-described terms may be used interchangeably. Although FIG. 1B illustrates an example of a fronthaul structure between a DU 160 and one RU 180, this is only for the sake of descriptive convenience, and the disclosure is not limited thereto. In other words, embodiments of the disclosure may also be applied to a fronthaul structure between one O-DU and multiple O-RUs as in FIG. 5. For example, embodiments of the disclosure may be applied to a fronthaul structure between one O-DU and two O-RUs. In addition, embodiments of the disclosure may be applied to a fronthaul structure between one O-DU and three O-RUs.

Referring to FIG. 1B, the base station 110 may include a DU 160 and an RU 180. The fronthaul 170 between the DU 160 and the RU 180 may be operated through an Fx interface. In order to operate the fronthaul 170, various fronthaul interfaces defined in specifications (for example, enhanced common public radio interface (eCPRI), radio over ethernet (ROE)) may be used.

Mobile data traffic has increased in line with developing communication technologies, and accordingly, the amount of bandwidths required in the fronthaul between a distributed unit and a radio unit has significantly increased. In a deployment such as a centralized/cloud radio access network (C-RAN), the DU 160 may be implemented to perform functions for the packet data convergence protocol (PDCP), radio link control (RLC), media access control (MAC), and physical (PHY), and the RU may be implemented to further perform the functions for the PHY layer, in addition to the radio frequency (RF) functions.

The DU 160 may handle upper layer functions of a radio network. For example, the DU 160 may perform functions of the MAC layer or a part of the PHY layer. As used herein, a part of the PHY layer refers to functions performed in upper steps among the PHY layer functions, and may include, for example, channel encoding (or channel decoding), scrambling (or descrambling), modulation (or demodulation), and layer mapping (or layer demapping). According to an embodiment, the DU 160 may be referred to as an O-DU (O-RAN DU) when following O-RAN specifications.

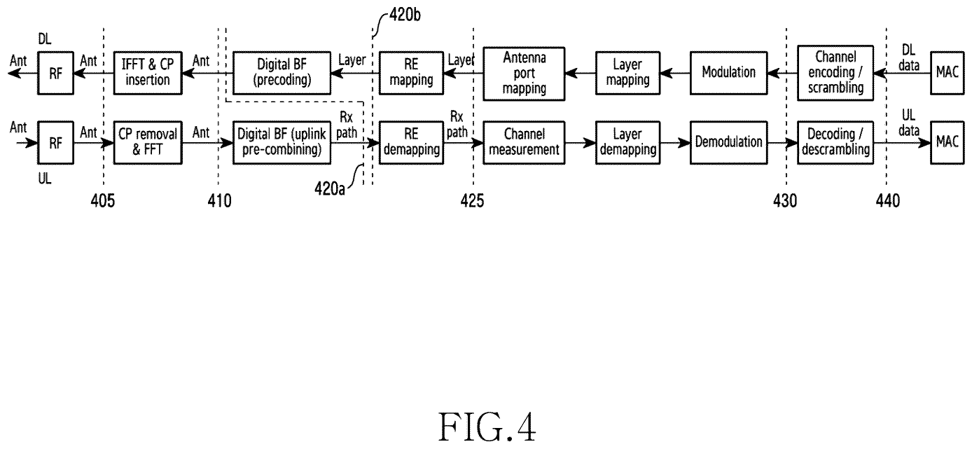

The RU 180 may handle lower layer functions of a radio network. For example, the RU 180 may perform a part of the PHY layer or RF functions. As used herein, a part of the PHY layer is performed in steps relatively lower than the DU 160, among functions of the PHY layer, and may include, for example, IFFT transform (or FFT transform), cyclic prefix (CP) insertion (CP removal), and digital beamforming. An example of such a specific function split will be described in detail with reference to FIG. 4. The RU 180 may be referred to as “access unit (AU)”, “access point (AP)”, “transmission/reception point (TRP)”, “remote radio head (RRH)”, “radio unit (RU)”, or other terms having equivalent technical meanings. According to an embodiment, The RU 180 may be referred to as an O-RU (O-RAN RU) when following O-RAN specifications.

Although it is assumed in the description with reference to FIG. 1B that the base station includes a DU 160 and an RU 180, various embodiments of the disclosure are not limited thereto. In some embodiments, the base station may be implemented in a distributed deployment, based on a centralized unit (CU) configured to perform functions of upper layers, for example, packet data convergence protocol (PDCP), or RRC, of an access network and a distributed unit configured to perform functions of lower layers. The distributed unit may include the distributed unit (DU) and the radio unit (RU) in FIG. 1B. The base station may be implement in a structure in which the CU, DU, and RU are deployed in that order between a core (e.g., 5G core (5GC) or next generation core (NGC)) network and a radio access network (RAN). The interface between the CU and the distributed unit may be referred to as an F1 interface.

The centralized unit (CU) may be connected to one or more DUs so as to handle functions of upper layers than the DUs. For example, the CU may handle the functions of radio resource control (RRC) and packet data convergence protocol (PDCP) layers, and the DU and RU may handle the functions of lower layers. The DU may perform some functions (high PHY) of radio link control (RLC), media access control (MAC), and physical (PHY) layers, and the RU may handle the remaining functions (low PHY) of the PHY layer. In addition, as an example, the distributed unit (DU) may be included in the distributed unit as the base station is implemented in a distributed deployment. As used hereinafter, a distributed unit (DU) may be understood as being identical to a distributed unit including no RU, for convenience of description. In addition, the distributed unit (DU) may be understood as being identical to an O-RAN distributed unit (0-DU) or O-RAN distributed unit.

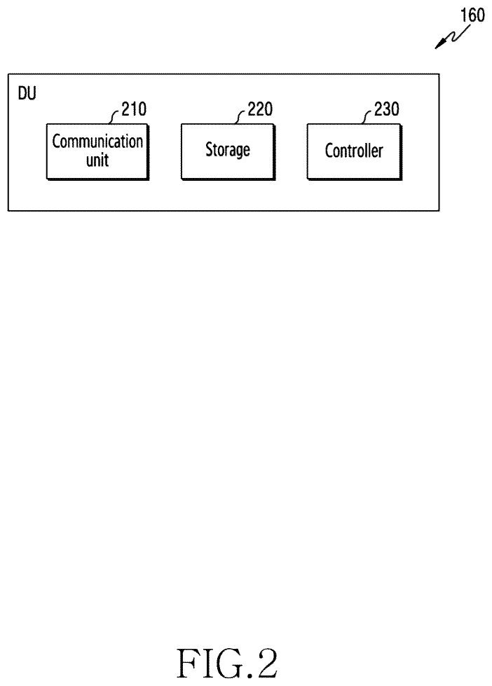

FIG. 2 illustrates a structure of a distributed unit 160 in a wireless communication system according to various embodiments of the disclosure. The exemplary structure illustrated in FIG. 2 may be understood as a structure of the DU 160 in FIG. 1B, as a part of the base station. As used herein, such terms as “ . . . unit“and” . . . er” refer to a unit configured to process at least one function or operation, and may be implemented as hardware, software, or a combination of hardware and software.

Referring to FIG. 2, the DU 160 includes a communication unit 210, a storage 220, and a controller 230.

The communication unit 210 may perform functions for transmitting/receiving signals in a wired communication environment. The communication unit 210 may include a wired interface for a direct connection between devices through a transmission medium (for example, copper wire or optical fiber). For example, the communication unit 210 may transfer electric signals to another device through a coper wire, or may perform conversion between electric signals and optical signals. The communication unit 210 may be connected to a radio unit (RU). The communication unit 210 may be connected to a core network or connected to a CU having a distributed deployment.

The communication unit 210 may perform functions for transmitting/receiving signals in a wireless communication environment. For example, the communication unit 210 may perform functions of conversion between baseband signals and bitstrings according to the physical layer specifications of the system. For example, during data transmission, the communication unit 210 encodes and modulates a transmitted bitstring to generate complex symbols. In addition, during data reception, the communication unit 210 demodulates and decodes a baseband signal to restore a received bitstring. In addition, the communication unit 210 may include multiple transmission/reception paths. In addition, according to an embodiment, the communication unit 210 may be connected to the core network or to other nodes (for example, integrated access backhaul (IAB)).

The communication unit 210 may transmit/receive signals. To this end, the communication unit 210 may include at least one transceiver. For example, the communication unit 210 may transmit a synchronization signal, a reference signal, system information, a message, a control message, a stream, control information, data, or the like.

The communication unit 210 transmits and receives signals as described above. Accordingly, all or part of the communication unit 210 may be referred to as a “transmitter”, a “receiver”, or a “transceiver”. In addition, as used in the following description, the meaning of “transmission and reception performed through a radio channel” includes the meaning that the above-described processing is performed by the communication unit 210.

Although not illustrated in FIG. 2, the communication unit 210 may further include a backhaul communication unit to be connected to the core network or other base stations. The backhaul communication unit provides an interface for communicating with other nodes in the network. That is, the backhaul communication unit converts bitstrings transmitted from the base station to other nodes, for example, other access nodes, other base stations, upper nodes, core networks, or the like to physical signals, and convers physical signals received from other nodes to bitstrings.

The storage 220 may store basic programs, application programs, and data, such as configuration information, for operation of the DU 160. The storage 220 may include a memory. The storage 220 may include a volatile memory, a nonvolatile memory, or a combination of a volatile memory and a nonvolatile memory. In addition, the storage 220 provides the stored data at the request of the controller 230.

The controller 230 controls the overall operation of the DU 160. For example, the controller 230 transmits and receives signals through the communication unit 210 (or through the backhaul communication unit). In addition, the controller 230 records data in the storage 230 and reads the data from the storage 220. Furthermore, the controller 230 may perform functions of protocol stacks required by communication specifications. To this end, the controller 230 may include at least one processor.

The structure of the DU 160 illustrated in FIG. 2 is only an example, and the example of the DU 160 performing various embodiments of the disclosure is not limited by the structure illustrated in FIG. 2. Some or like components may be added, omitted, or changed according to various embodiments.

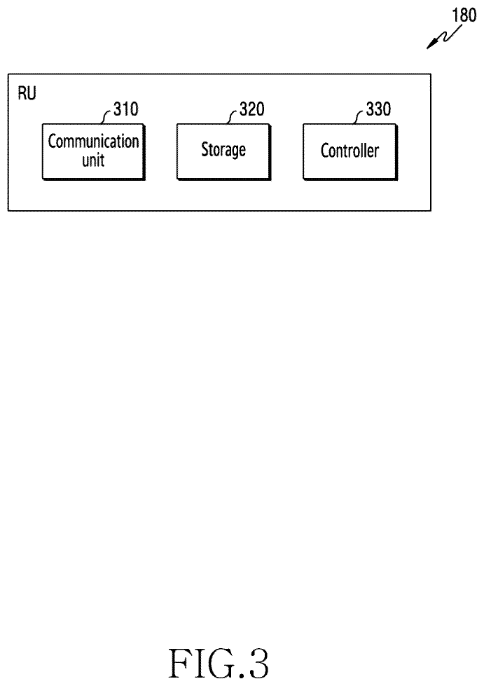

FIG. 3 illustrates a structure of a radio unit (RU) in a wireless communication system according to various embodiments of the disclosure. The exemplary structure illustrated in FIG. 3 may be understood as a structure of the RU 180 in FIG. 1B, as a part of the base station. As used herein, such terms as “ . . . unit“and” . . . er” refer to a unit configured to process at least one function or operation, and may be implemented as hardware, software, or a combination of hardware and software.

Referring to FIG. 3, the RU 180 includes a communication unit 310, a storage 320, and a controller 330.

The communication unit 310 performs functions for transmitting/receiving signals through a radio channel. For example, the communication unit 310 up-converts a baseband signal to an RF band signal, transmits the same through an antenna, and down-converts an RF band signal received through the antenna to a baseband signal. For example, the communication unit 310 may include a transmission filter, a reception filter, an amplifier, a mixer, an oscillator, a digital-to-analog converter (DAC), an analog-to-digital converter (ADC), and the like.

In addition, the communication unit 310 may include multiple transmission/reception paths. Furthermore, the communication unit 310 may include an antenna unit. The communication unit 310 may include at least one antenna array configured by multiple antenna elements. In terms of hardware, the communication unit 310 may include a digital circuit and an analog circuit (e.g., a radio frequency integrated circuit (RFIC)). The digital circuit and the analog circuit may be implemented as a single package. In addition, the communication unit 310 may include multiple RF chains. The communication unit 310 may perform beamforming. The communication unit 310 may apply beamforming weights to signals in order to assign directivity to signals to be transmitted/received, based on configurations of the controller 330. According to an embodiment, the communication unit 310 may include a radio frequency (RF) block or a RF unit.

In addition, the communication unit 310 may transmit/receive signals. To this end, the communication unit 310 may include at least one transceiver. The communication unit 310 may transmit a downlink signal. The downlink signal may include a synchronization signal (SS), a reference signal (RS) (e.g., cell-specific reference signal (CRS)), a demodulation (DM)-RS, system information (e.g., MIB, SIB, remaining system information (RMSI), and other system information (OSI)), a configuration message, control information, downlink data, or the like. In addition, the communication unit 310 may receive an uplink signal. The uplink signal may include a random access-related signal (e.g., a random-access preamble (RAP) (or message 1 (Msg1) and message 3 (Msg3)), a reference signal (e.g., a sounding reference signal (SRS) and a DM-RS), a power headroom report (PHR), or the like.

The communication unit 310 transmits and receives signals as described above. Accordingly, all or part of the communication unit 310 may be referred to as a “transmitter”, a “receiver”, or a “transceiver”. In addition, as used in the following description, the meaning of “transmission and reception performed through a radio channel” includes the meaning that the above-described processing is performed by the communication unit 310.

The storage 320 may store basic programs, application programs, and data, such as configuration information, for the operation of the RU 180. The storage 320 may include a volatile memory, a nonvolatile memory, or a combination of a volatile memory and a nonvolatile memory. In addition, the storage 320 provides the stored data at the request of the controller 330. According to various embodiments of the disclosure as described below, the storage 320 may include a memory for performing processing of beamforming weights or operations for IFFT transform.

The controller 330 controls the overall operation of the RU 180. For example, the controller 330 transmits and receives signals through the communication unit 310. In addition, the controller 330 records data in the storage 320 and reads the data from the storage 320. In addition, the controller 330 may perform functions of protocol stacks required by communication specifications. To this end, the controller 330 may include at least one processor. In some embodiments, the controller 330 may be configured to transmit an SRS to the DU 160, based on an antenna number. In addition, in some embodiments, the controller 330 may be configured to transmit an SRS to the DU 160 after uplink transmission. Conditional commands according to SRS transmission schemes or configuration values are codes or a set of instructions stored in the storage 320, and the controller 330 may be a storage space in which instructions/codes at least temporarily residing in the controller 330 or instructions/codes are stored, or may be a part of circuitry constituting the controller 330. In addition, the controller 330 may include various modules for performing communication. For example, the controller 330 may control the RU 180 to perform the operations according to various embodiments as described below. For example, the controller 330 may control a beamforming block and an IFFT block included in the RU 180 and specific components included in each block to be operated according to various embodiments of the disclosure as described below.

According to various embodiments of the disclosure, the above-described unit is merely an example and the disclosure is not limited thereto, and it will be apparent that the RU 180 may include various blocks or units according to various embodiments as described below. For example, the RU may further include a block for precoding data or applying beamforming weights, a block for IFFT transform, or a block for performing IFFT or inserting a CP. Hereinafter, examples of more specific RU structures including various blocks will be described, and it will be apparent that operations performed by the RU are described for the sake of convenience and may refer to operations performed by particular components of the RU respectively.

FIG. 4 illustrates an example of a function split in a wireless communication system according to various embodiments of the disclosure. In line with development of wireless communication technologies (for example, introduction of 5th generation (5G) communication systems (or new radio (NR) communication systems)), employed frequency bands have increased further, and then substantially reduced cell radius of base stations has further increased the number of RUs to be installed. In addition, in 5G communication systems, the amount of transmitted data has increased up to 10 times, and the amount of transmission in wired networks made through the fronthaul has substantially increased accordingly. Due to such factors, the cost for installing wired networks in 5G communication systems may increase substantially. Therefore, technologies have been proposed, in order to decrease the amount of transmission in wired networks and to reduce the cost for installing wired networks, such that some functions of the DU's modem are relocated to the RU, thereby decreasing the amount of transmission made through the fronthaul, and such technologies may be referred to as “function split”.

A scheme of expanding the role of the RU which handles only RF functions to some functions of the physical layer, in order to reduce the burden of the DU, is considered. As the RU performs functions of a higher layer, the amount of processing by the RU may increase, thereby increasing the transmission bandwidth through the fronthaul, and simultaneously reducing restrictions on delay time requirements resulting from response processing. Meanwhile, as the RU performs functions of a higher layer, virtualization gain decreases, and the size/weight/cost of the RU increases. It is required to implement an optimal function split in consideration of the trade-off between the advantages and disadvantages described above.

Referring to FIG. 4, FIG. 4 illustrates function splits in MAC or lower layers. In the case of a downlink (DL) via which signals are transmitted to the UE through a radio network, the base station may successively perform channel encoding/scrambling, modulation, layer mapping, antenna mapping, resource element (RE) mapping, digital beamforming (e.g., precoding), IFFT transform/CP insertion, and RF transform. In the case of an uplink (UL) via which signals are received from the UE through the radio network, the base station may successively RF transform, FFT transform/CP removal, digital beamforming (pre-combining), RE demapping, channel estimation, layer demapping, demodulation, and decoding/descrambling. The split between uplink functions and downlink functions may be defined in various types according to needs between vendors, discussion on specifications, and the like, based on the above-described trade-off.

A first function split 405 may be a split between RF functions and PHY functions. The first function split is such that PHY functions are not substantially implemented in the RU, and may be referred to as Option 8, for example. A second function split 410 is such that the RU performs IFFT transform/CP insertion in the DL and performs FFT transform/CP removal in the UL of PHY functions, and the DU performs the remaining PHY functions. As an example, the second function split 410 may be referred to as Option 7-1. A third function split 420a is such that the RU performs IFFT transform/CP insertion in the DL and performs FFT transform/CP removal and digital beamforming in the UL of PHY functions, and the DU performs the remaining PHY functions. As an example, the third function split 420a may be referred to as Option 7-2x Category A. A fourth function split 420b is such that the RU performs up to digital beamforming in both the DL and UL, and the DU performs upper PHY functions following the digital beamforming. As an example, the fourth function split 420b may be referred to as Option 7-2x Category B. A fifth function split 425 is such that the RU performs up to RE mapping or RE demapping in both the DL and UL, and the DU performs upper PHY functions following the RE mapping or RE demapping. As an example, the fifth function split 425 may be referred to as Option 7-2. A sixth function split 430 is such that the RU performs up to modulation or demodulation in both the DL and UL, and the DU performs upper PHY functions following the modulation or demodulation. As an example, the sixth function split 430 may be referred to as Option 7-3. A seventh function split 440 is such that the RU performs up to encoding/scrambling or decoding/descrambling in both the DL and UL, and the DU performs upper PHY functions following the modulation (or demodulation). As an example, the seventh function split 440 may be referred to as Option 6.

According to an embodiment, in case that a large amount of signal processing is expected as in FR1 MMU, a function split in a relatively higher layer (e.g., the fourth function split 420b) may be required to reduce the fronthaul capacity. Also, a function split in an extremely higher layer (e.g., the sixth function split 430) has problems in that control interfaces become complicated and a plurality of PHY processing blocks included in the RU may impose a burden on implementation of the RU, and thus an appropriate function split is required according to the RU and DU deployment and implementation scheme.

According to an embodiment, in case that precoding of data received from the DU cannot be handled (i.e., in case that the precoding capability of the RU is limited), the third function split 420a or a lower level of function split (e.g., the second function split 410) may be applied. To the contrary, in case that precoding of data received from the DU can be handled, the fourth function split 420b or a higher level of function split (e.g., the sixth function split 430) may be applied.

Hereinafter, various embodiments of the disclosure will be described with reference to the third function split 420a (category A) or the fourth function split 420b (category B), unless otherwise specified, such that the RU processes beamforming, but embodiments may also be configured through other function splits. It will be apparent that functional configurations, signaling, or operations described below with reference to FIG. 5 to FIG. 16 may be applied to not only the third function split 420a or the fourth function split 420b, but also the other function splits.

According to various embodiments of the disclosure, an application protocol of the fronthaul between the DU and RU may include a control plane (C-plane), a user plane (U-plane), a synchronization plane (S-plane), and a management plane (M-plane).

According to an embodiment, the control plane may be configured to provide scheduling information and beamforming information through a control message. According to an embodiment, the user plane may include a user's downlink data (in-phase/quadrature-phase (IQ) data or SSB/RS), uplink data (IQ data or SSB/RS), or PRACH data. The above-described beamforming information′ weight vector may be multiplied by the user's data. According to an embodiment, the synchronization plane may be related to timing and synchronization. According to an embodiment, the management plane may be related to initial setup, non-real-time reset, or reset, and non-real-time report.

According to an embodiment, section types are defined in order to define the types of messages transmitted in the control plane. The section types may indicate uses of a control message transmitted in the control plane. For example, the uses according to the section types are as follows.
sectionType=0: DL idle/guard periods —Use for Tx blanking for power saving
sectionType=1: Mapping BF index or weight (O-RAN mandatory BF scheme) to RE of DL/UL channel
section Type=2: reserved
section Type=3: Mapping beamforming index or weight to PRACH and mixed-numerology channel
section Type=4: reserved
section Type=5: Deliver UE scheduling information so as to allow RU to calculate realtime BF weight (O-RAN optional BF scheme)
section Type=6: Periodically deliver UE scheduling information so as to allow RU to calculate realtime BF weight (O-RAN optional BF scheme)
section Type=7: Used for supporting LAA

FIG. 5 illustrates an example of a connection between a DU and an RU according to various embodiments of the disclosure. A description has been given based on one RU connected to one DU in FIG. 1 to FIG. 4. However, embodiments according to the disclosure may also be applied between multiple radio units (RUs) connected to one distributed unit (DU).

According to various embodiments of the disclosure, an O-DU 160 may refer to the DU 160 in FIG. 1B and FIG. 2, and an O-RU 180 may refer to the RU 180 in FIG. 1B and FIG. 3. That is, the descriptions of the DU 160 and the RU 180 may be equally applied to descriptions of the O-DU 160 and the O-RU 180 in FIG. 1 to FIG. 16, respectively. It will be apparent that although the O-DU and O-RU based on the O-RAN specifications are illustrated by way of example in FIG. 1 to FIG. 16 for the sake of descriptive convenience, the following descriptions may be equally applied to the DU and the RU based on 3GPP.

Various embodiments of the disclosure are described by taking, as an example, an 0-RU/MMU (massive multiple-input and multiple-output (MIMO) unit) (e.g., an O-RU or an RU) in a wireless communication system conforming to an open radio access network (0-RAN) interface, in which downlink (DL) function split uses 7-2x Category-B (CAT-B). However, the disclosure is not limited thereto, and it is apparent that the disclosure may be applied to various cases of function split. Hereinafter, according to various embodiments of the disclosure, a scheme for enabling optimized use of a memory for precoding within a low-PHY (LPHY) DL block will be described.

According to one embodiment, an LPHY DL block of an O-RU/MMU configured as 7-2x CAT-B may receive DL layer IQ data in a frequency domain, which is RE-mapped, from a DU through an ORAN fronthaul. The DL layer IQ data may be converted into DL antenna IQ data by applying precoding defined by a beamforming weight matrix. In this case, a memory in which the beamforming weight matrix is stored and a capacity of the memory may be required.

Various embodiments of the disclosure provide, in a process of solving the above-described problem, a scheme for optimizing memory resources and power consumption required to store information such as a matrix, by using a dimension of the beamforming weight matrix.

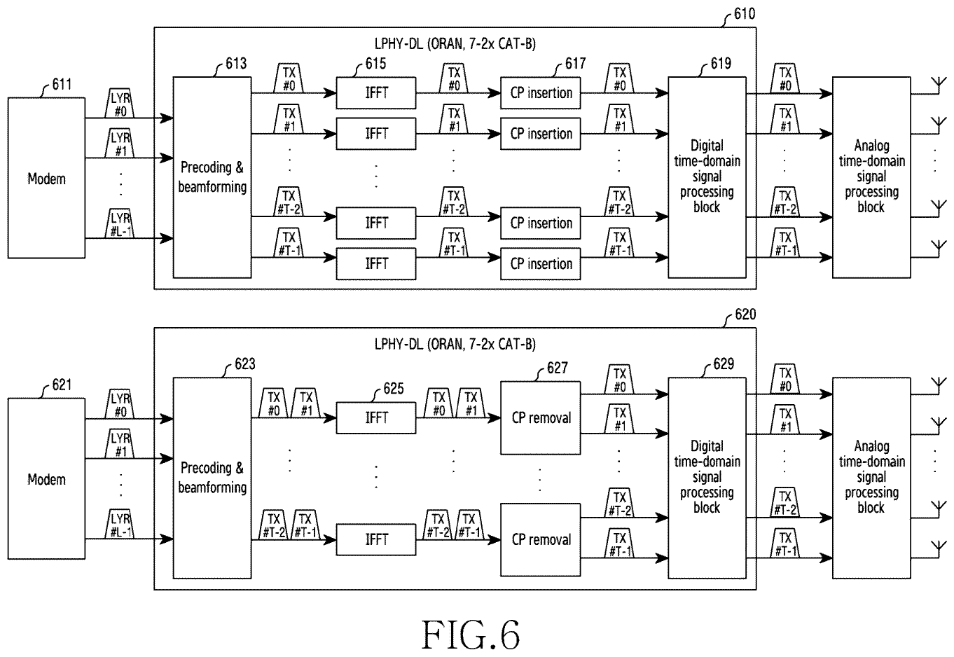

FIG. 6 illustrates a structure of a downlink chain block of an RU according to various embodiments of the disclosure. Specifically, FIG. 6 includes a first downlink chain structure 610 including blocks for converting a downlink digital signal into an analog signal for transmission, and a second downlink chain structure 620 including blocks for converting a downlink digital signal into an analog signal when a clock frequency is twice as large as a sample rate of the downlink signal.

An MMU/RU (hereinafter, RU) of a wireless communication system may process signals between a modem 611, 621 (for example, including a DU) and a UE. More specifically, an LPHY-DL 610, 620 of the RU may receive DL layer IQ data symbols in a frequency domain from the modem 611, 621 through a user plane (U-plane). The LPHY-DL of the RU may receive, from the modem 611, 621 through a control plane (C-plane), a beam identifier (beamId) for determining a beamforming weight matrix in order to generate an optimal beam in consideration of resource scheduling and a transmission channel environment.

According to an embodiment, the LPHY-DL block 610, 620 of the RU may apply, in a block 613, 623 for precoding and beamforming, the beamforming weight matrix determined according to the beamId to the DL layer IQ data, and, in this case, the RU may acquire (or, hereinafter, the same as “generate) DL IQ symbol data for each antenna.

According to an embodiment, an IFFT block 615, 625 of the RU may apply an IFFT, on an N-point symbol basis, to an acquired frequency domain digital signal in an orthogonal frequency division multiplexing (OFDM) for each antenna, thereby converting the digital signal into a time domain digital signals. A CP insertion block 617, 627 of the RU may add or insert a CP into the digital signal and transmit the digital signal to a next signal processing block. Thereafter, the time domain DL signal may be converted into an analog radio signal in a time domain digital signal processing block and may be radiated through an antenna, and the UE may receive the radiated radio signal.

According to an embodiment, when an operating clock frequency of each block is an integer multiple of a sample rate of a signal, the signals of integer-multiple paths may be processed within the same time in a single IFFT block 615, 625. Here, the clock frequency may refer to a generation period of a clock pulse used to synchronize operations performed within a system of the RU. The sample rate may refer to a speed required to process conversion between an analog signal and a digital signal. That is, when a speed at which signals can be processed within the system of the RU is n times as large as a speed required to process the signals, signals of n paths may be processed within the same time in a single processing block (for example, the IFFT block 615, 625).

The second downlink chain structure 620 illustrates a structure of downlink blocks in which signals of 2 paths are simultaneously processed when the clock frequency of a block is twice as large as the DL sample rate. According to an embodiment, the second downlink chain structure 620 may include a feature in which signals of 2 paths are processed as a 2 path MUX through time multiplexing (hereinafter, interchangeably referred to as MUX for convenience) in the IFFT block 625, and may otherwise include blocks and functions that are similar or identical to those of the first downlink chain structure 610.

Hereinafter, various examples for processing multiple signals (layer IQ data or antenna IQ data) by multiplexing, for the purpose of reducing memory usage, will be described according to various embodiments of the disclosure, but this is not limited thereto, and it is obvious that the operations and structures of various embodiments may be applied according to the first downlink structure 610.

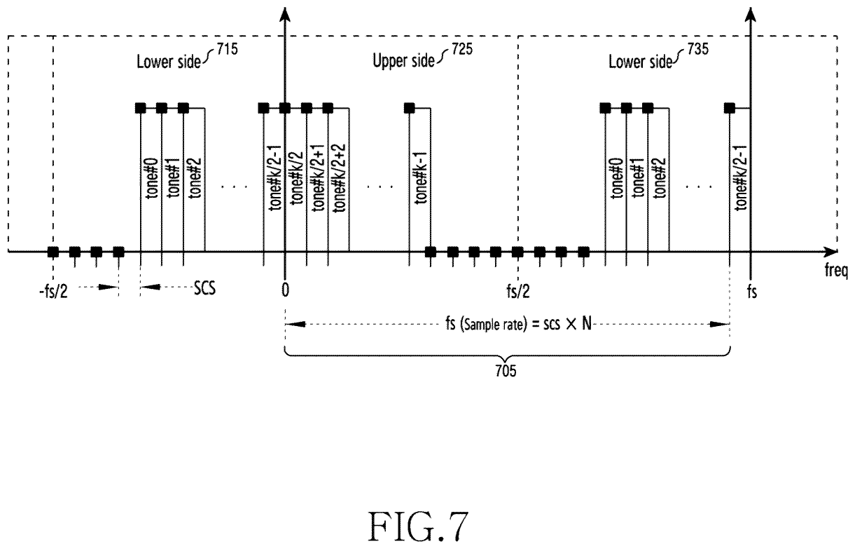

FIG. 7 illustrates an example of a frequency spectrum for inverse fast Fourier transform (IFFT) conversion according to various embodiments of the disclosure. Specifically, referring to FIG. 7, a frequency domain spectrum for performing IFFT conversion by IFFT processing on k tones within a sample rate 705 of the downlink signal is illustrated.

Hereinafter, various embodiments of the disclosure will be described in detail with reference to various specific examples of operations for processing a frequency domain signal in an IFFT block.

According to an embodiment, a signal in the frequency domain may have a spectrum repeated along a frequency axis at a period corresponding to a sampling rate. When k tones within the sampling rate (705) are subjected to an N-point IFFT conversion (for example, k<N), a spectrum in the frequency domain may appear as illustrated in FIG. 7.

Referring to FIG. 7, fs may refer to the sample rate 705. One tone may refer to one sub-carrier spacing (SCS), and when one symbol includes an N-point IFFT, fs may be derived as in Equation 1:

$$fs = scs \times N$$

According to an embodiment, in a frequency domain, a signal may have a spectrum repeated along a frequency axis at a period corresponding to a sampling rate. Accordingly, referring to FIG. 7, it may be expected that a lower-side signal located in a range of (−fs/2, 0) 715 repeatedly appears in a range of (fs/2, fs) 735.

At this time, since a physically implemented N-point IFFT block requires N point samples in a positive region (for example, a range of (0, fs) 725) in order to perform an IFFT operation, k tones of a downlink signal need to have an order changed (for example, by an IFFT conversion (shift)), as illustrated in FIG. 7, and a memory for IFFT conversion may be used to perform such an IFFT conversion.

For example, according to a signal repeated at a period corresponding to a sampling rate, it may be expected that a lower-side signal located in a range of (−fs/2, 0) 715 is identically repeated in a range of (fs/2, fs) 735. Accordingly, an N-point IFFT block, which is required to perform an operation using N point samples in a range of (0, fs) 725, 735, may perform IFFT conversion based on tones of a signal including expected tones (for example, expected tones in the range of (fs/2, fs) 735). To this end, before performing an IFFT operation, it is necessary to change an order of the lower-side signal located in the range of (−fs/2, 0) 715 to the range of (fs/2, fs) 735, and in this process, a memory for IFFT conversion may be required.

According to various embodiments of the disclosure, as described above, IFFT conversion may be performed on k tones illustrated in FIG. 7 for IFFT processing. At this time, when a clock frequency of a system is n times as large as a sample rate (fs), symbols of layer IQ data or antenna IQ data of n paths may be processed within the same time. Hereinafter, specific details of such multi-path MUX will be described.

According to an embodiment, referring to 3GPP TS 38.211 v16.2.0 “Physical Channels and Modulation,” a symbol length may be defined as an N-IFFT symbol plus a CP. The following, e.g., I and II, describes a relationship among a constant (K), numerology (u), and a CP, and related contents as described in 3GPP TS 38.211 v16.2.0.

I. Frame Structure and Physical Resources: Unless otherwise explicitly specified throughout this specification, the sizes of various fields in the time domain are expressed in time units as {T_{c}=1/(Δfₘₐₓ·N_{f}), where Δfₘₐₓ=480·10³ H_{z} and N_{f}=4096}. A constant is expressed as {κ=Tₛ/T_{c}=64, where Tₛ=1/(Δf_{ref}·N_{f,ref}), Δf_{ref}=15·10³ H_{z}, and N_{f,ref}=2048}. Unless otherwise explicitly specified throughout this specification, clauses in which the term “UE” is used in Clauses 4, 5, 6, or 7 are equally applicable to the IAB-MT part of an IAB node. As shown in the table below, multiple OFDM numerologies are supported. Here, μ, and cyclic prefixes for downlink and uplink bandwidth parts may each be obtained from higher-layer parameters subcarrierSpacing and cyclicPrefix, respectively.

TABLE 1
Supported transmission numerology

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

According to the contents described above, in general, sizes of various fields in a time domain may be expressed by units inversely proportional to a subcarrier spacing and the number of samples N. In addition, information on a subcarrier spacing and a CP for transmission of an uplink or downlink signal may be acquired as upper layer parameters.

### II. OFDM Baseband Signal Generation: OFDM Baseband Signal Generation for all Channels Except PRACH and RIM-RS.

In all physical channels or signal subframes except PRACH, for an OFDM symbol

$$OFDM l ∈ \{ 0 , 1 , … , {N}_{slot}^{subframe , μ} {N}_{symb}^{slot} - 1 \}$$

at symbol antenna port p and subcarrier spacing configuration μ, a time-continuous signal

$${s}_{l}^{( p , μ )} ( t )$$

is defined in Equation 2:

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix}$$

$${\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - {N}_{CP , l}^{μ} {T}_{c} - {t}_{start , l}^{μ} )}$$

$${k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ} \vert$$

$${T}_{symb , l}^{μ} = ( {N}_{u}^{μ} + {N}_{CP , l}^{μ} ) {T}_{c}$$

At the start of a subframe, t=0, and

$${N}_{u}^{μ} = 2048 κ \cdot {2}^{- μ}$$

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{μ} \\ 144 κ \cdot {2}^{- μ} & normal cyclic prefix , l \neq 0 and l \neq 7 \cdot {2}^{μ}\end{matrix}$$

and Δf is given in I; μ is a subcarrier spacing configuration; μ₀ is a largest μ value among subcarrier spacing configurations according to scs-SpecificCarrierList for an uplink and a downlink, respectively; and sl-SCS-SpecificCarrierList for a sidelink.

According to an embodiment, a time-continuous signal S may be derived according to the Equation 2 described above, and accordingly, the N of the symbol according to the CP may be derived. By reorganizing this, symbol durations for each SCS are calculated as shown in Table 2 below, which shows symbol duration times for each subcarrier spacing (SCS) in an N-point FFT/IFFT.

TABLE 2
Symbol duration times for each subcarrier spacing (SCS) in an N-point FFT/IFFT.

| | SCS | | CP for long symbols | | CP for remaining symbols | |
|---|---|---|---|---|---|---|
| μ | [kHz] | K | #Samples | Time[μs] | #Samples | Time[μs] |
| 0 | 15 | 1 | 2208 × (N/2048) | 71.875 | 2192 × (N/2048) | 71.354 |
| 1 | 30 | 4 | 4448 × (N/4096) | 36.198 | 4384 × (N/4096) | 35.677 |
| 2 | 60 | 4 | 2208 × (N/2048) | 17.969 | 2192 × (N/2048) | 17.836 |

According to an embodiment, in a case of an LPHY-DL block that supports an SCS of 30 kHz, a bandwidth (BW) of 100 MHz corresponding to 3276 tones, and a 4096-point IFFT, when a system clock frequency operates at 245.76 MHz, a 2-path MUX may be performed to optimize hardware (HW) resources. For example, in a case where an SCS is 30 kHz and a 4096-point IFFT is used, a symbol length including a CP (for example, a normal CP rather than an extended CP) may be 35.677 s. When such a symbol length is calculated based on a 245.76 MHz clock, 8768 clock cycles, for example, 35.677 μs×245.76 MHz, may be derived. That is, when samples are processed per clock, data corresponding to two symbols (2×4096) may be processed simultaneously. However, this is merely an example, and depending on various parameters such as a subcarrier spacing and a clock frequency, data processed per clock may correspond to two or more symbols, for example, four symbols. That is, according to various embodiments of the disclosure, the disclosure is not limited to the above-described example, and two or more signal data may be multiplexed and processed.

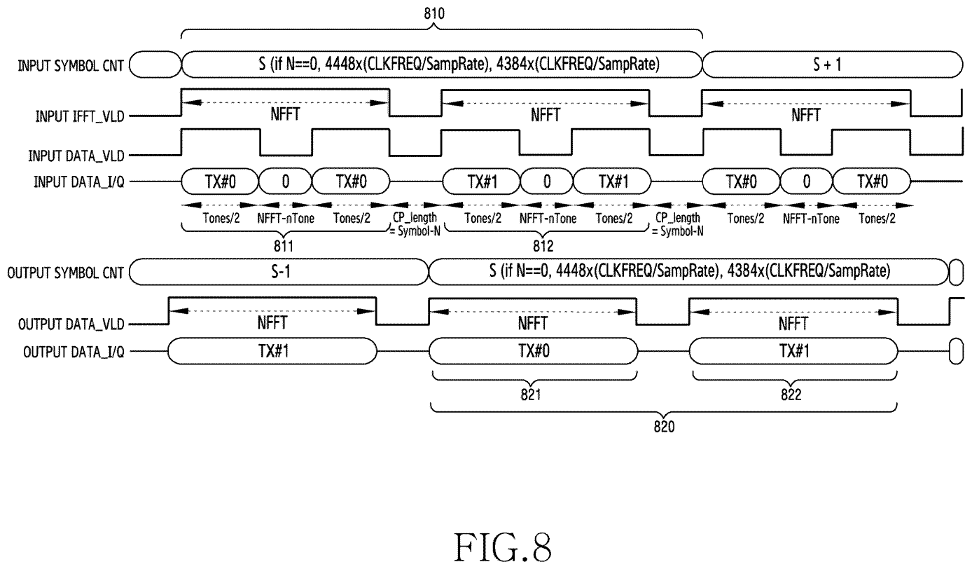

As described above, signal paths having two or more sample rates may be multiplexed and processed within a clock frequency, and an example illustrating this through a time-series timing diagram is shown in FIG. 8.

FIG. 8 illustrates an example of timing for a path multiplexer (MUX) according to various embodiments of the disclosure. Specifically, referring to FIG. 8, when two paths are multiplexed, an example of timing for input and output of an IFFT block is illustrated. More specifically, FIG. 8 illustrates an example of timing for a case in which each layer IQ data is converted into antenna IQ data through precoding or beamforming operations, and then two antenna IQ data are multiplexed and subjected to IFFT processing.

Referring to FIG. 8, one input symbol S 810 may include multiplexed antenna IQ data TX #0 811 and TX #1 812 corresponding to antenna indices #0 and #1. TX #0 811 and TX #1 812 may each be data acquired based on layer IQ data on which IFFT conversion has been performed. According to an embodiment, after IFFT processing of the input symbol, one output symbol S 820 may include IFFT-processed antenna IQ data TX #0 821 and TX #1 822.

Hereinafter, in order to perform input and output operations of the IFFT block of FIG. 8, beamforming weight application and more specific MUX operations for acquiring multiplexed antenna IQ data will be described in detail.

According to an embodiment, referring to FIG. 8, when a clock frequency is twice as large as a sample rate, signals for two antenna paths may be processed within one symbol duration. For example, during an input value count of symbol S, tones for TX #0 and tones for TX #1 may be processed. These may be processed and output as output antenna IQ data for TX #0 and output antenna IQ data for TX #1 during an output value count of symbol S.

That is, as described above, each layer IQ data to which IFFT conversion is applied may have precoding and beamforming weights applied thereto, and accordingly, each acquired antenna IQ data may be multiplexed (Multiplexed) among two or more paths and processed within a single symbol count.

According to an embodiment, as described above, antenna IQ data obtained by applying the beamforming weights may be multiplexed on a per-path basis and transmitted to the IFFT block. In this case, a MUX rate (for example, a MUX ratio) may be derived according to Equation 3:

$$( MUX Rate ) = \frac{( Clock Frequency )}{( Sampling Rate )} .$$

Hereinafter, a specific example in which IFFT conversion is performed on each layer IQ data, and accordingly, layer-specific memories required therefor will be described.

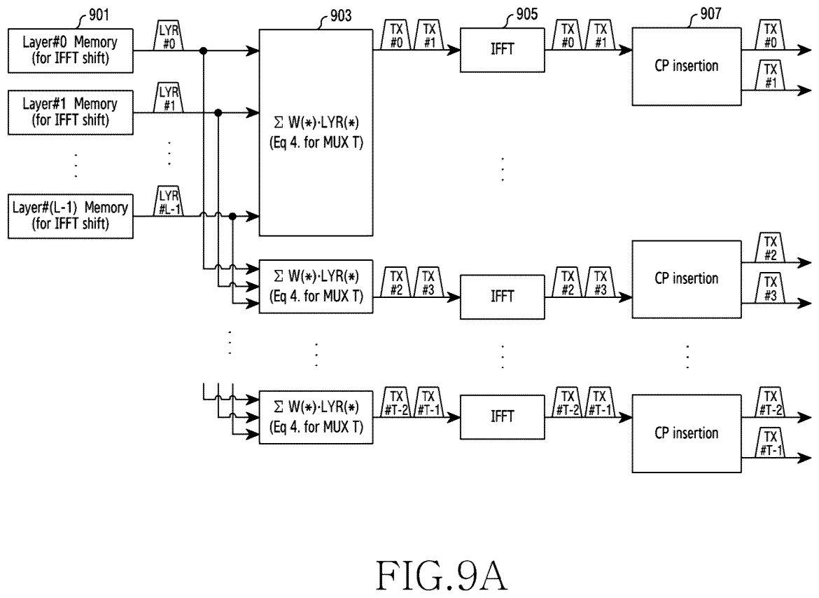

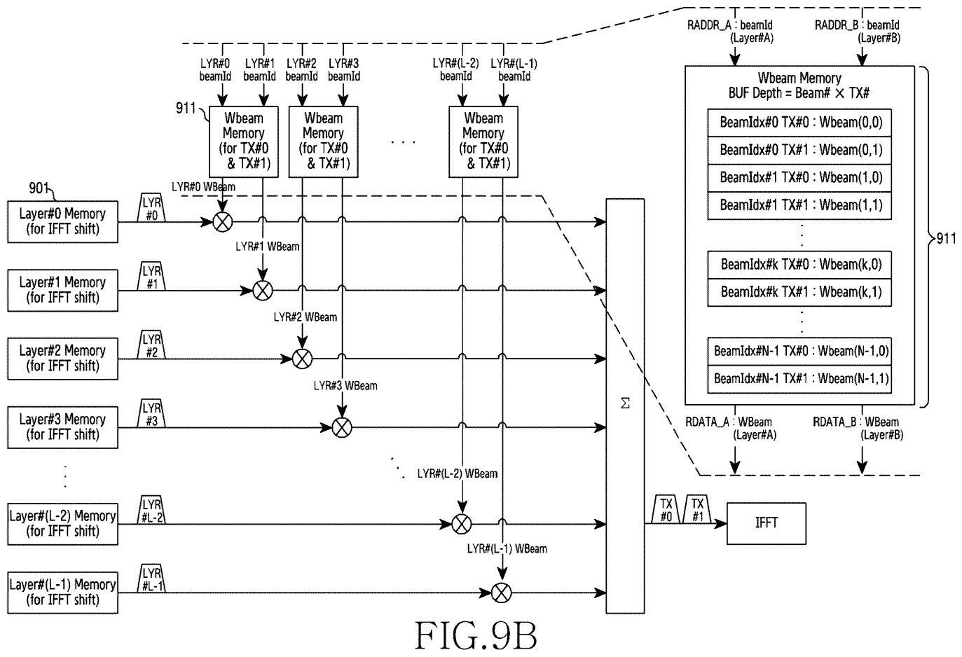

FIG. 9A illustrates a detailed structure of a downlink chain block including an IFFT conversion position according to various embodiments of the disclosure.

According to various embodiments of the disclosure, layer IQ data may be subjected to IFFT conversion using layer-specific memories 901. According to an embodiment, all layer IQ data on which IFFT conversion has been performed may be processed through a beamforming processing block 903 to be converted into respective antenna IQ data.

According to an embodiment, IFFT input symbol data transmitted to an IFFT, that is, antenna IQ data, may include a result to which a beamforming weight matrix is applied. In this case, in a beamforming processing block 903, a process in which downlink layer IQ data is converted into antenna IQ data on a per-path basis based on the beamforming weight matrix may be derived according to Equation 4 and Equation 5 below.

$${( \begin{matrix}{ANT}_{0} \\ {ANT}_{1} \\ {ANT}_{2} \\ ⋮ \\ {ANT}_{T - 1}\end{matrix} )}_{( T \times 1 )} = {( \begin{matrix}{W}_{0 , 0} & {W}_{0 , 1} & ⋯ & {W}_{0 , L - 1} \\ {W}_{1 , 0} & {W}_{1 , 1} & ⋯ & {W}_{1 , L - 1} \\ {W}_{2 , 0} & {W}_{2 , 1} & ⋯ & {W}_{2 , L - 1} \\ ⋮ & ⋮ & ⋱ & ⋮ \\ {W}_{T - 1 , 0} & {W}_{T - 1 , 1} & ⋯ & {W}_{T - 1 , L - 1}\end{matrix} )}_{( T \times L )} \cdot {( \begin{matrix}{LYR}_{0} \\ {LYR}_{1} \\ ⋮ \\ {LYR}_{L - 1}\end{matrix} )}_{( L \times 1 )} . \qquad Equation 4$$

Here, L may denote the number of layers supported by a system, T may denote the number of antennas supported by the system, and W may denote a beamforming weight. In addition, L may be less than or equal to T.

$$ANT {( x )}_{k} = {\sum }_{l = 0}^{L - 1} {W ( x )}_{k , l} \cdot {LYR ( x )}_{l} . \qquad Equation 5$$

Here, LYR may denote a layer matrix, W may denote a beamforming weight matrix, and ANT may denote an antenna matrix.

According to an embodiment, in order to derive a value for one antenna, values of all layers may be used. According to an embodiment, L indicating the number of layers is less than or equal to T indicating the number of antennas, and since signal-specific memories are used to perform IFFT conversion, IFFT conversion may be performed for the smaller number of layers than the number of antennas. That is, rather than performing IFFT conversion after IQ data is converted into antenna IQ data, IFFT conversion may be performed on layer IQ data, thereby saving usage of a memory 901 for IFFT conversion. FIG. 9A is a block diagram illustrating an IFFT conversion position to which the above-described structure is applied, and referring to FIG. 9A, memories 901 for IFFT conversion may be positioned for each layer in front of a block 903 for converting into antenna IQ data. According to an embodiment, antenna IQ data obtained by applying beamforming weights may be multiplexed as a 2-path MUX and subjected to IFFT processing in an IFFT block 905, and thereafter, CPs may be inserted into respective symbols and processed in a CP insertion block 907.

According to an embodiment, as derived in Equation 5, an antenna k path corresponding to a specific resource element (RE)*may be a total sum of products of all layer IQ data corresponding to the RE*and beamforming weight IQs corresponding to the respective layer IQ data.

At this time, the beamforming weight matrix W may be changed at an RE resolution according to a channel environment and scheduling. In a case of an RU/MMU of an O-RAN system, during an initial cell setup, a W set table for each antenna may be stored in a buffer through an M-plane. The RU/MMU may also indicate W to be applied to each RE*, based on a beamId received through a C-plane.

According to an embodiment, when the number of cases that beamId may have is b, the W set table may have a size corresponding to a product of b and the number of antennas (for example, b×T).

The beam identifier (beamId) is a parameter defines a beam pattern to be applied to U-plane data. A beamId of 0 indicates that no beamforming operation is performed. Not performing a beamforming operation means that an RU does not apply phase or amplitude weights to U-plane data, and as a result, an RF signal is applied identically to all antenna elements of a group.

The beamId encodes beamforming to be performed at an 0-RU. Such beamforming may be digital, analog, or a combination thereof (“hybrid beamforming”), and the beamId provides all information necessary for the O-RU to select an appropriate beam (or a weight table or beam attribute for generating the beam). The beamId shall be globally unique with respect to an O-RU, meaning that, for all Rtcid/Did pairs, the same beamId is shared within an O-RU. An UL or DL may have 32,767 available beams (with beamId=0x0000 reserved for a case where no beamforming is applied). Specific mappings of a beamId to parameters such as a weight table, beam attributes, beam direction, beam adjacency, or other beam identifiers depend on an 0-RU design and shall be delivered from the O-RU to an O-DU through an M-plane at startup.

For DL and UL, an upper limit on the maximum number of beam IDs that can be processed per eAxC or per eAxC set, per symbol, and per slot shall be delivered through an M-plane message as part of an O-RU capability description. In addition, in a case where an O-RU has a limitation on C-plane message processing, an additional constraint is applied such that, with respect to the eAxC limitation, the number of sections having the highest priority is limited.

The value range includes {0000 0000 0000 0001b-1111 1111 1111 1111b; 0000 0000 0000 0000b indicates that BF is not performed}. The type is Unsigned integer. The field length is 15 bits. The default value is 0000 0000 0000 0000b (no beamforming).

According to an embodiment, as described above, referring to ETSI TS 103 859 v7.0.2, “Publicly Available Specification (PAS); O-RAN Fronthaul Control, User and Synchronization Plane Specification,” a beamId is defined as 15 bits, and accordingly, b may be defined as 32,767 cases excluding a 0 bit.

Hereinafter, specific examples of a buffer or capacity required for a memory, for example, a beam weight memory, for a W set table and the like in a beamforming processing block 903 will be described based on the block structure of FIG. 9A described above.

FIG. 9B illustrates a detailed structure of a downlink chain block including a memory for precoding and beamforming according to various embodiments of the disclosure.

As illustrated in FIG. 9A, for antenna path multiplexing (MUX), tones need to be delivered to an IFFT input in a clock-stream manner on a per-clock basis. That is, multiplexed antenna IQ data signals input to an IFFT block 905 may continuously deliver tones based on a clock frequency. Accordingly, operations for applying precoding and beamforming weights of Equation 5 may also be performed on a per-clock basis.

Referring to FIG. 9B, in order to support the above-described clock-stream transmission, beamIds and beamforming weights, in an IFFT-converted form, need to be readable from a memory 911 on a per-clock basis for the number corresponding to each layer. That is, a usage amount of a memory (for example, a memory for beamforming weights) 911 storing a W set table may be (b×T×L×BFw_IQ), considering both a bit-width BFw_IQ of beamforming weights and the number of layers that need to be simultaneously read from the memory 911.

According to an embodiment, the memory 911 described above may include a dual-port random access memory (RAM). When a dual-port RAM is used, since one memory 911 may support input/output of two ports, in a case where a specific beamId is input and read, a usage amount of the memory 911 for beamforming weights may be reduced to (b×T×L/2×BFw_IQ). For example, referring to FIG. 9B, when beamIds of layers #0 to #(L-1) in an IFFT-converted form are processed through the memory 911 for antenna TX #0 and antenna TX #1, the memory 911 may require a buffer capacity corresponding to the number of all layers for two antennas and the number of cases of beamId. Ultimately, the memory 911 may require a size for performing all layer-specific operations (or, in a case of a dual-port configuration, half of the total number of layers).

As another example, in a case of a dual-port memory, the memory 911 for two layers needs to be capable of storing W set tables corresponding to the number of cases of beamId for multiplexed antenna paths TX #0 and TX #1, and ultimately, a buffer may be required in consideration of the number of memories 911 for all layers for the multiplexed antenna paths TX #0 and TX #1. According to an embodiment, beamforming weights may be applied on a per-layer basis as described above, and after multiplexing of antenna IQ data is performed, signals may be delivered to an IFFT block.

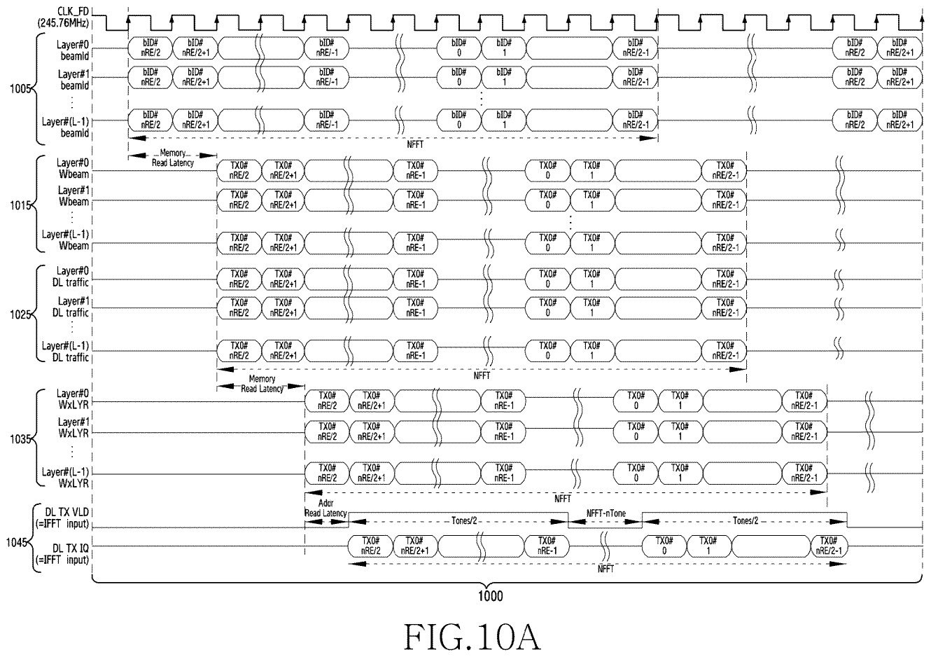

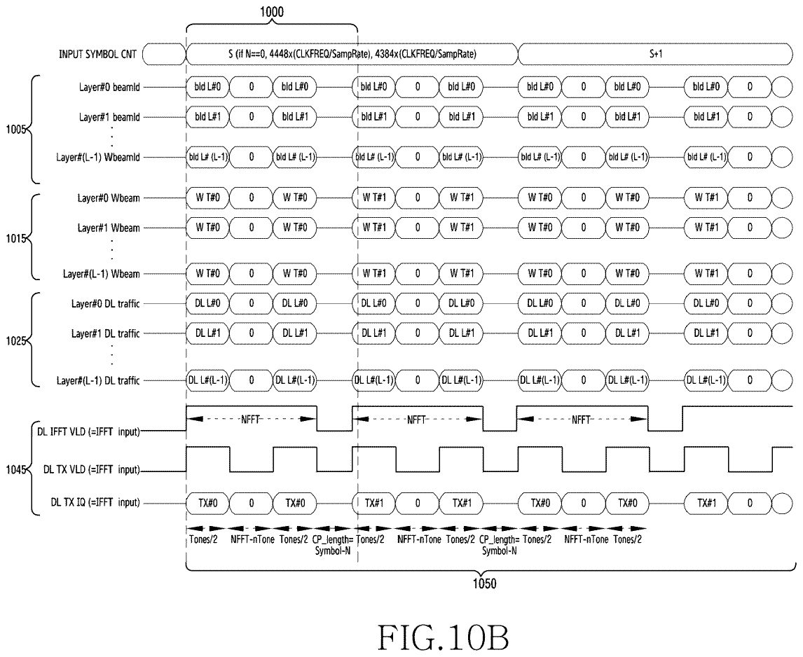

FIGS. 10A and 10B illustrate an example of timing regarding precoding and beamforming according to various embodiments of the disclosure. More specifically, FIGS. 10A and 10B illustrate timing diagrams based on the blocks described in FIGS. 9A and 9B.

According to an embodiment, referring to FIGS. 10A and 10B, an example of timing for applying beamforming weights is illustrated for in a case where an SCS is 30 kHz and 4096-point IFFT is used and a clock frequency operates at 245.76 MHz, that is, in a case of a 2-path MUX.

According to an embodiment, a first timing diagram 1000 of FIG. 10A illustrates an example of applying beamforming weights for acquiring antenna IQ data TX #0 corresponding to antenna index #0. A second timing diagram 1050 of FIG. 10B includes the first timing diagram 1000 as a part thereof, and illustrates an example in which antenna IQ data signals multiplexed in two paths are processed as IFFT input signals for IFFT processing.

Referring to FIG. 10A, according to an embodiment, beamIds may be applied to layer IQ data signals 1005 for respective layer indices. In this case, each layer IQ data signal may be a signal on which IFFT conversion has been performed. For example, one layer IQ data signal may include tones of (nRE, 2nRE-1) to which a beamId is applied during one NFFT, and tones of (0, nRE/2-1) to which a beamId is applied.

According to an embodiment, through memory reading for applying beamforming weights, DL traffic tones 1025 for respective layers for TX #0 and beam weights 1015 corresponding thereto may be identified. According to an embodiment, through complex multiplication in which a beamforming weight matrix is applied to the layers, an antenna IQ data signal (for example, a signal corresponding to TX #0) 1035 may be acquired, and an antenna IQ data signal 1045 for an IFFT input may be acquired.

Referring to FIG. 10B, a second timing diagram 1050 illustrates, from a broader perspective, a timing diagram including two antenna data paths (for example, TX #0 and TX #1) per one symbol count, based on the first timing diagram 1000 of FIG. 10A. Similar to the above-described case, beamIds may be applied to layer IQ data signals 1005 for respective layer indices, and the layer IQ data signals may be signals on which IFFT conversion has been performed. Based thereon, DL traffic tones 1025 for respective layers for TX #0 and beam weights 1015 corresponding thereto may be identified, and through complex multiplication, an antenna IQ data signal 1045 for an IFFT input may be acquired.

According to an embodiment, the second timing diagram 1050 may include two antenna IQ data signals (for example, TX #0 and TX #1) during an interval of one symbol count S or S+1. As described above, in order to acquire 2-path Multiplexed antenna IQ data for an IFFT input, operations of applying beamIds and applying beamforming weights are performed for all layers, and accordingly, an excessive usage amount of memory may be required.

According to various embodiments of the disclosure, based on the structure of the beamforming weight application block described above, usage amounts of a memory and a multiplier may be derived as shown in Equation 6 to Equation 8 below.

$$IFFT shift memory size ( bit ) = ( Layer IQ bitwidth ) \times 2 ( symbol ) \times ( N point IFFT ) \times L . \qquad Equation 6$$

That is, a usage amount of a memory for IFFT conversion may be represented as a product of a layer IQ bit length, two symbols, an N-point IFFT size, and the number of layers. In this case, since symbol # even and symbol #odd are processed together for IFFT conversion, two symbols may be considered.

$$Wbeam memory size ( bit ) = ( Weight IQ bitwidth ) \times b \times T \times \frac{L}{2} . \qquad Equation 7$$

That is, a usage amount of a beam weight memory may be represented as a product of a beam weight IQ bit length, the number of cases of a beamId (b) (for example, 2\hat{ }(beamId bitwidth), the number of antennas, and half of the number of layers (for example, in a case of a dual-port configuration).

$$Precoding complex multiplier = L \times \frac{T}{MUX rate} . \qquad Equation 8$$

That is, the number of precoding complex multipliers may be represented as a product of the number of layers and the number of antennas divided by a MUX rate (for example, (clock frequency)/(maximum sampling rate)).

As described above, a downlink beamId of a wireless communication system has a bit length of 15 bits and thus may indicate that beams may have 32,768 possible cases. In addition, since IFFT conversion is performed at a layer IQ symbol dimension, when beam weights or precoding are applied, in order to perform parallel layer operations, beam weight dual-port memories including identical content (for example, a W set table) need to be replicated by L/2. Such a structure may require a significant amount of memory usage, and in a case where a digital logic device cannot accommodate the usage amount required according to the above-described structure, it may become a factor that limits other characteristics such as required capacity. Further, even in a case where a high-cost digital logic device capable of accommodating the above usage amount is used, as the memory usage increases, power consumption may increase proportionally, may cause a negative influence on the system.

According to various embodiments of the disclosure, in an LPHY-DL block structure included in an RU of a wireless communication system, a time-sharing structure of layer data and corresponding specific operations and implementation schemes for optimizing usage amounts of a beam weight memory and an IFFT conversion memory by improving inefficiencies of the above-described structure will be described in detail below. In addition, together therewith, various embodiments for optimizing resources required for hardware implementation and for reducing power consumption and heat generation of a circuit, thereby enabling miniaturization and cost reduction of hardware, will be described.

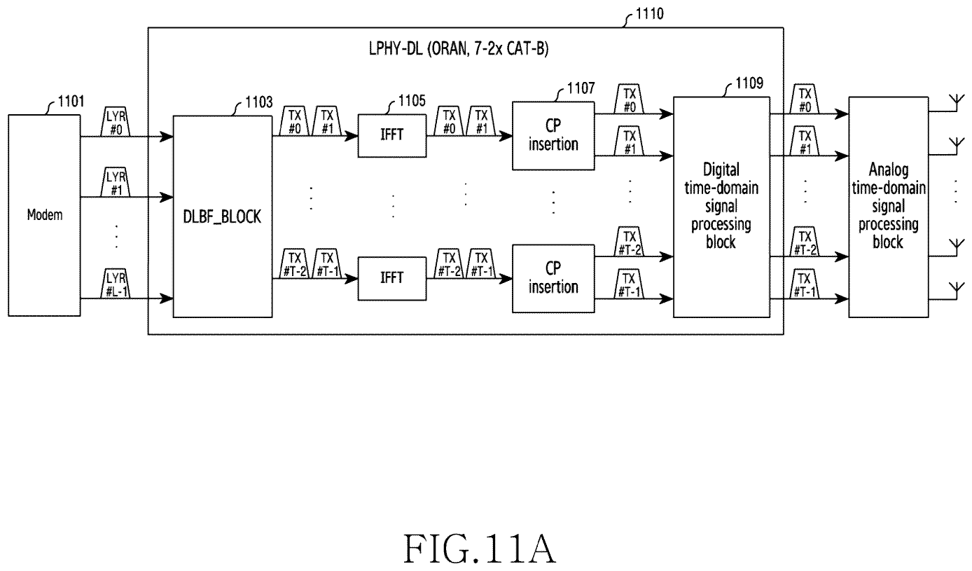

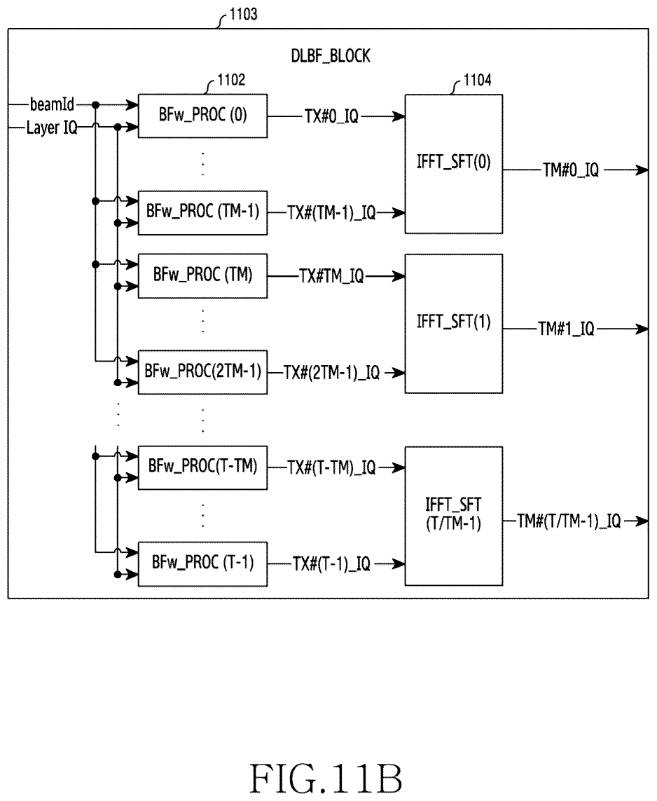

FIGS. 11A and 11B illustrate a downlink chain block including a beamforming block and a structure of a beamforming block for performing beamforming and IFFT conversion according to various embodiments of the disclosure.

As described above, various embodiments of the disclosure will be described based on an LPHY-DL structure of ORAN 7-2x CAT-B, but are not limited thereto. Referring to FIG. 11A, an LPHY-DL block of an RU according to an embodiment (hereinafter, referred to as an RU for convenience) 1110 may include a beamforming block 1103, for example, a DLBF_BLOCK (downlink beamforming block), positioned in front of an IFFT block 1105. In addition, the RU may further include a CP insertion unit 1107 and a digital time-domain signal processing block 1109. For example, the RU may receive layer IQ data on which resource mapping has been performed from a modem 1101, for example, a DU. The beamforming block 1103 may acquire antenna IQ data by applying beamforming weights or applying precoding to the received layer IQ data. Here, beamforming weights may be applied to layer IQ data in a state where multiple paths are multiplexed. Antenna IQ data acquired by the beamforming block 1103 may be delivered to the IFFT block 1105 in a state where multiple paths are multiplexed. According to an embodiment, antenna IQ data in which multiple paths are multiplexed may be delivered to the IFFT block 1105 after being IFFT-converted in the beamforming block 1103. Thereafter, the antenna IQ data that has undergone IFFT processing in the IFFT block 1105 may be delivered to the CP insertion unit 1107, and a CP may be inserted into each antenna IQ data. As described above, antenna IQ data symbols into which the CP is inserted may be converted into analog signals through a digital signal processing block 1109 and an analog signal processing block and may be radiated.

Referring to FIG. 111B, a beamforming block 1103 including at least one beamforming weight processing (BFw_PROC) block 1102 and at least one IFFT conversion block 1104 e.g., IFFT shift or IFFT_SFT is illustrated. According to various embodiments of the disclosure, the beamforming weight processing block 1102 of the beamforming block 1103 may be positioned in front of the IFFT conversion block 1104. For example, each layer IQ data delivered from a modem 1101, (for example, a DU) and each corresponding beamId may be delivered to respective beamforming weight processing blocks 1102, beamforming weights may be applied thereto, and thereafter, the data may be delivered to the IFFT conversion block 1104 for IFFT conversion. According to various embodiments of the disclosure, the beamforming block 1103 may apply beamforming weights to multiplexed layer-level signals (for example, layer IQ data), separately from multiplexing of antenna IQ data. Detailed descriptions thereof will be provided below.

According to an embodiment, the beamforming weight processing block 1102 may include a memory storing a beamforming weight table (for example, a table having a size corresponding to the number of beamId cases×the number of layers×one antenna) and a processing unit configured to perform an operation of Equation 5. In this case, since a processing capacity for the operation may correspond to one antenna per one symbol, the beamforming block 1103 may include beamforming weight processing blocks 1102 corresponding to the number of antennas. Referring to FIG. 11B, an index of each beamforming weight processing block may indicate an antenna index.

According to an embodiment, the IFFT conversion block 1104 may store, in the memory, outputs of the beamforming weight processing block 1102 for respective antenna paths by an antenna MUX rate such as TM, (for example, the number of paths that are multiplexable). Thereafter, the IFFT conversion block 1104 may perform IFFT conversion on output signals for respective antenna paths to enable IFFT operation, and may deliver the converted signals to an IFFT block 1105. Referring to FIG. 11B, an index of the IFFT conversion block may indicate an index of Multiplexed antenna data.

According to various embodiments of the disclosure, unlike FIGS. 9A and 9B, the beamforming block 1103 of FIGS. 11A and 11B may include a structure in which IFFT conversion is performed after application and computation of beamforming weights (for example, a structure in which IFFT conversion is performed immediately before the IFFT block 1105). Since IFFT conversion is performed after beamforming weight computation, the beamforming block 1103 may perform layer time MUX when computing beamforming weights.

According to an embodiment, since the number of layers L supported by a system is less than or equal to the number of antennas T (L≤T), performing IFFT conversion in an antenna dimension rather than in a layer dimension may indicate that a memory usage amount increases in direct proportion to a difference between T and L. However, as described below, the beamforming block structures of FIGS. 11A and 11B may reduce a memory usage amount for applying beamforming weights more than an increase in memory usage caused by a change in an IFFT conversion block structure, thereby achieving a greater memory reduction effect.

In order to concretize various effects and operations of the disclosure as described above, according to an embodiment, a case may be considered in which a beamforming block 1103 supporting an SCS of 30 kHz, a bandwidth (BW) of 100 MHz (3276 tones, 4096-point IFFT), and 16 layers-32 antennas operates at a clock frequency of 245.76 MHz. In addition, a layer MUX rate (LM) and an antenna MUX rate (TM), which are used below, may be defined by Equation 9 and Equation 10 below.

$$( LM ) = QUOTIENT [ \frac{( SYM\_CLKCNT )}{( nRE )} ] . \qquad Equation 9$$

Here, SYM_CLKCNT may denote a normal symbol clock count value, and nRE may denote the number of resource elements (REs). That is, a layer MUX rate (LM), which is a ratio at which layer IQ data are multiplexed, may be derived as a quotient obtained by dividing the normal symbol clock count value by the number of REs.

$$( TM ) = \frac{( Clock Frequency )}{( Max Sampling Rate )} . \qquad Equation 10$$

That is, an antenna MUX rate (TM), which is a ratio at which antenna IQ data are multiplexed, may be derived by dividing a system clock frequency by the maximum sample rate.

According to an embodiment, under the conditions described above, a normal symbol length may be 35.677 s with reference to Table 2, and when the normal symbol length is converted based on a 245.76 MHz clock, SYM_CLKCNT may be 8,768 clock cycles. Accordingly, when the number of tones and the number of clock cycles under the above conditions are substituted into Equation 9, a layer MUX rate (LM) may be 2.

Accordingly, two layer IQ data corresponding to a specific beamId may be multiplexed on a per-clock basis and delivered to the beamforming block 1103. That is, before delivering layer IQ data to the beamforming weight processing block 1102 of the beamforming block 1103, the RU may multiplex layer IQ data received from a modem 1101, for example, a DU, based on the LM value determined in consideration of the above-described conditions, and the multiplexed layer IQ data may be delivered, based on corresponding beamIds, to beamforming weight processing blocks 1102 corresponding to respective antenna indices.

When the above-described structure is used, a beam weight (W beam) memory may store a table corresponding to an antenna index processed by the beamforming weight processing block 1102. Accordingly, one beam weight memory may process beamIds individually for layers corresponding to the LM. Therefore, when the total number of layers is L, the number of beam weight memories required to process a signal corresponding to one antenna may be L/(LM).

According to an embodiment, the beam weight memory may be configured as a dual-port memory. Accordingly, one beam weight memory may process beamIds individually for layers corresponding to 2×LM. Therefore, when the total number of layers is L, the number of beam weight memories required to process a signal corresponding to one antenna may be L/(2×LM).

Hereinafter, a structure for applying signals to respective memories for layer-Multiplexed signals and corresponding beamforming weight processing blocks 1102 will be described in further detail.

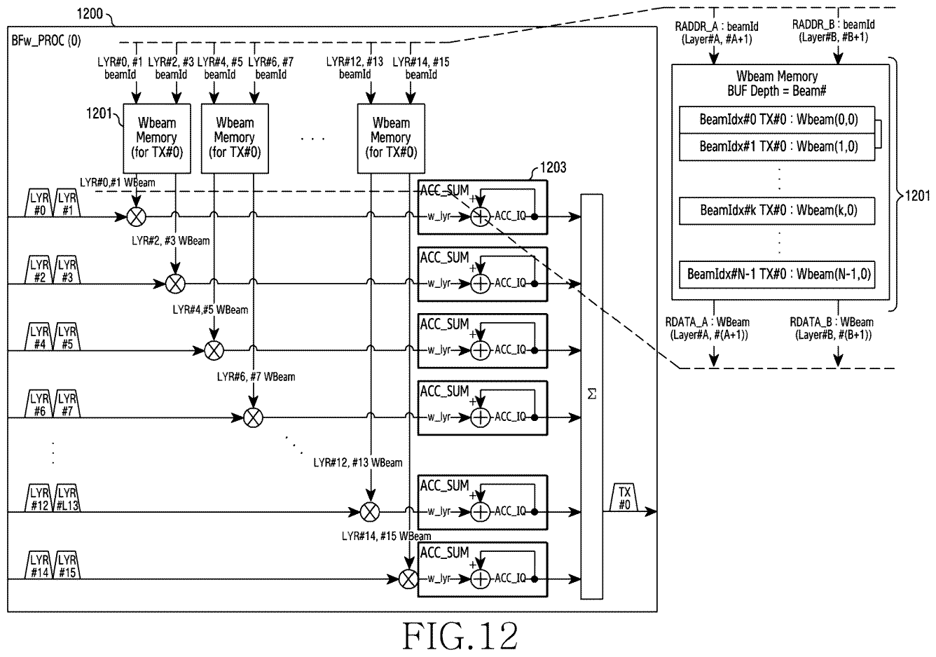

FIG. 12 illustrates another specific structure of a downlink chain block including a memory for precoding and beamforming according to various embodiments of the disclosure. Referring to FIG. 12, a specific structure of a beamforming weight processing block for processing one antenna (for example, one piece of antenna IQ data TX #0) is illustrated. According to an embodiment, the beamforming weight processing block 1200 of FIG. 12 may perform beamforming weight processing for acquiring TX #0 associated with antenna index #0.

Referring to FIG. 12, unlike the beam weight memory of FIG. 9B, one beam weight memory 1201 may include a beamforming weight table for a beamId and two multiplexed layers corresponding thereto. According to an embodiment, since data may be multiplexed on a per-layer basis before beamforming weights are applied, the number of memories 1201 corresponding to all layers is not required, and thus, the number of the memories 1201 may be reduced by a layer data multiplexing ratio (or rate). Here, two multiplexed layer IQ data are merely an example, and it is to be understood that n layer IQ data may be multiplexed according to a MUX ratio, and the number of the memories 1201 may also be reduced correspondingly.

According to an embodiment, as described above with reference to FIG. 12, the number of beam weight memories 1201 may be inversely proportional to an LM value. Accordingly, a usage amount of the beam weight memory 1201 and a usage amount of complex multipliers may be represented as shown in Equation 11 and Equation 12 below.

$$Wbeam memory size ( bit ) = ( Weight IQ bitwidth ) \times b \times T \times \frac{L}{( 2 \times LM )} . \qquad Equation 11$$

That is, a usage amount of a beam weight memory may be proportional to a beam weight IQ bit length, the number of cases of a beamId (b) (for example, 2\hat{ }(beamId bitwidth)), the number of antennas, and the number of layers, and may be inversely proportional to an LM value and 2 (for example, in a case of a dual-port configuration).

$$Precoding complex multiplier = \frac{T}{LM} \times T . \qquad Equation 12$$

That is, the number of precoding complex multipliers may be represented as a product of a value obtained by dividing the number of layers by the LM value and the number of antennas.

According to an embodiment, referring to FIG. 12, in a case where each of one or more multiplexed layers and beamIds corresponding thereto are processed through a memory 1201 for antenna TX #0, the memory 1201 may require a buffer capacity corresponding to the number of all layers for antenna TX #0 and the number of beamId cases. However, the number of the memories 1201 of FIG. 12 is not required to be equal to the total number of all layers, and only the number inversely proportional to the number of multiplexed layers is required. That is, the memory 1201 may require only a value obtained by dividing the total number of layers by an LM value (or, in a case of a dual-port configuration, a value obtained by dividing the total number of layers by 2×LM) in order to perform per-layer operations.

As another example, in a case of a dual-port memory 1201, the memory 1201 for two 2-path-Multiplexed layer pairs (for example, layers # a and #(a+1), and layers #b and #(b+1)) may store W set tables corresponding to the number of beamId cases for antenna TX #0, and ultimately, a usage amount of the memory for an antenna path TX #0 may require a buffer in consideration of a layer MUX rate.

However, referring to FIG. 12, layers may be shared in time at an LM rate on a per-clock basis. Accordingly, an operation for accumulating one or more pieces of multiplexed layer IQ data is further required. According to an embodiment, the beamforming weight processing unit 1200 may further include an accumulation block 1203 for each of one or more pieces of multiplexed layer data. For example, the accumulation block 1203 for multiplexed layer data, for example, layer data in which layer #0 and layer #1 are multiplexed, may accumulate each of the multiplexed layers to which beamforming weights are applied, for example, layer #0+layer #1. The algorithm for the accumulation block 1203 may be expressed as follows.

ACC_SUM

```
if (w_lyr_valid == 1)
    if (cnt_lm ==LM−1)
      cnt_lm <= 0
    else
      cnt_lm <= cnt_lm + 1
else
    cnt_lm <= 0
If (cnt_lm == 0)
  ACC_IQ <= w_lyr
else
  ACC_IQ <= w_lyr + ACC_IQ
```

According to an embodiment, the accumulation block 1203 may accumulate layers multiplexed based on the above-described conditions such that a summation (sum) operation is performed for each of tones corresponding to each resource element (RE).

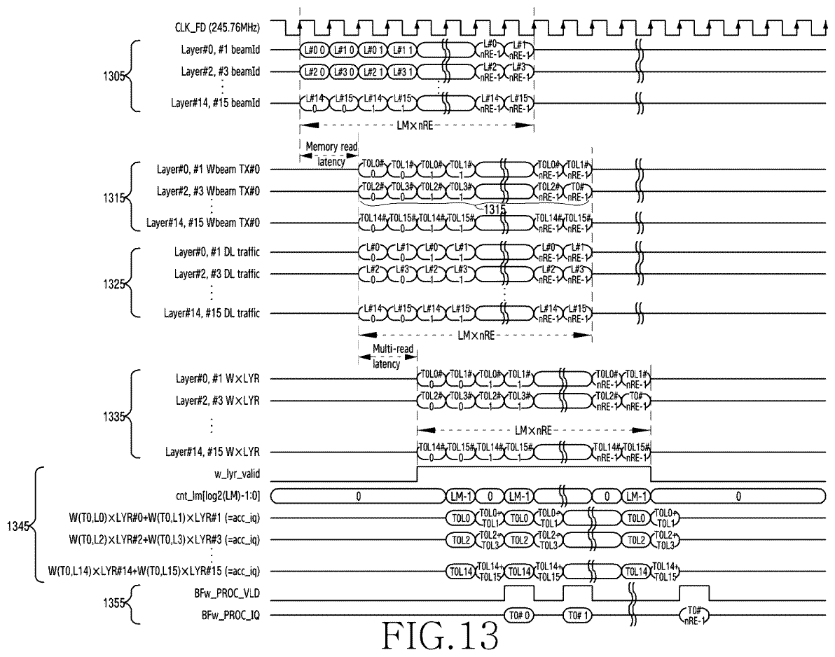

FIG. 13 illustrates another example of timing regarding precoding and beamforming according to various embodiments of the disclosure. More specifically, FIG. 13 illustrates a timing diagram based on the beamforming weight processing block of FIG. 12.

According to an embodiment, the timing diagram of FIG. 13 illustrates an example of applying beamforming weights for acquiring antenna IQ data TX #0 corresponding to antenna index #0.

Referring to FIG. 13, according to an embodiment, beamIds may be applied to layer IQ data signals 1305 for respective layer indices. In this case, each layer IQ data signal may be a layer data signal on which layer multiplexing has been performed based on an LM value. For example, one multiplexed layer data signal may include layer IQ data to which a beamId is applied with a length of (LM×nRE).

According to an embodiment, through memory reading for applying beamforming weights, DL traffic REs 1325 for each of the multiplexed layers corresponding to TX #0 and beam weights 1315 corresponding thereto may be identified. According to an embodiment, through complex multiplication in which a beamforming weight matrix is applied to each of the multiplexed layers, an antenna IQ data signal 1335, (for example, a signal corresponding to TX #0) 1335 may be acquired, and an antenna IQ data signal 1345 in which accumulation of the multiplexed layers is performed may be acquired. Based thereon, when beamforming weight application operations are completed, antenna IQ data signals 1355 for respective REs corresponding to antenna TX #0, which are beamforming-weight-processed IQs, may be acquired.

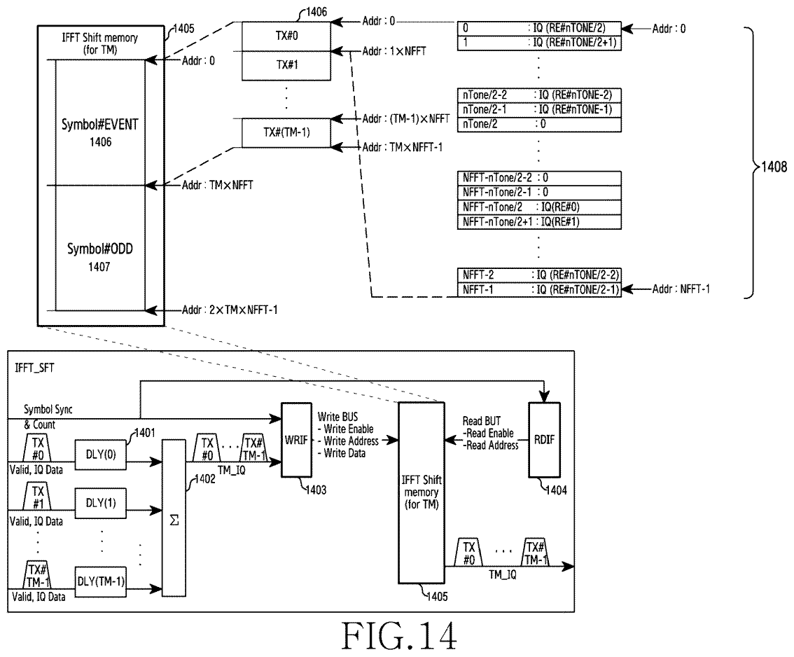

FIG. 14 illustrates a specific structure of a block for IFFT conversion according to various embodiments of the disclosure. More specifically, FIG. 14 illustrates an IFFT conversion block for performing IFFT conversion for applying IFFT to multiplexed antenna IQ data after application of beamforming weights. According to an embodiment, the IFFT conversion block disclosed in FIG. 14 may be applied, based on the same principle, to both a structure according to FIG. 9A and a structure according to FIG. 11A.

According to an embodiment, as described above, in order to optimize the usage amount of an IFFT operation block, antenna paths may be shared (for example, multiplexed) during one symbol duration. Since data output from a beamforming weight processing block corresponds to one path, an IFFT conversion block may simultaneously store TM paths in a memory, and thereafter may time-multiplex (time-MUX) the data in an IFFT-converted form and deliver the data to a next block. For example, respective antenna IQ data may be delivered to DLY blocks 1401 corresponding to respective antenna paths, and the antenna IQ data may be summed through a summation block 1402 on a per-multiplexed-path basis. Signals multiplexed based on TM may be processed based on a write interface (WRIF) block 1403 or a read interface (RDIF) block 1404, and ultimately, IFFT conversion may be performed based on an IFFT conversion memory 1405. Hereinafter, according to an embodiment, the term “processing” may include various operations performed for IFFT conversion, including read and write operations.

According to an embodiment, a DLY(n) 1401 block may delay a received signal by n clocks. For example, an output of a beamforming weight processing block positioned in front of an IFFT conversion block may have one sample every LM clocks. As described above, since LM may be greater than or equal to TM, the DLY(n) 1401 block may delay the received signal by each TM index, and the delayed signals may be added by the summation block 1402, thereby obtaining a result equivalent to multiplexing.

According to an embodiment, the WRIF block 1403 may generate a write address and a write enable, based on IFFT conversion and an antenna TM index, for signals received via antenna paths that are time-multiplexed. For example, the WRIF block 1403 may process multiplexed antenna data based on the following conditional statement and deliver signals to the IFFT conversion memory block 1405 for IFFT conversion. The algorithm for the WRIF block 1403 may be expressed as follows.

WRIF

```
if (Symbol Sync == 1)
  tm_cnt <= 0
  wr_cnt <= (NFFT − nTONE/2)
else
  if (Valid == 1)
    if (tm_cnt == TM−1)
      tm_cnt <= 0
      if (wr_cnt == NFFT−1)
        wr_cnt <= 0
      else
        wr_cnt <= wr_cnt +1
    else
      tm_cnt <= tm_cnt + 1
      wr_cnt <= wr_cnt;
WR_ENABLE <= valid
WR_ADDR <= (Symbol_CNT[0], tm_cnt; wr_cnt)
WDATA <= IQ_data
```

According to an embodiment, the IFFT conversion memory block 1405 may convert downlink symbol IQ data of TM antenna paths into an IFFT conversion format. According to an embodiment, since processing operations including writing and reading may be performed simultaneously for each symbol, the IFFT conversion memory block 1405 may be configured as a double buffer. For example, the usage amount of memory used in one IFFT conversion block may be derived according to Equation 13 below.

$$IFFT shift memory size ( bit ) = ( antenna IQ bitwidth ) \times 2 ( symbol ) \times ( N point IFFT ) \times TM . \qquad Equation 13$$

According to an embodiment, the RDIF block 1404 may generate a read address and a read enable, based on an interface of an IFFT operation block, such that antenna IQ data signals of TM paths are read from an IFFT conversion memory block 1405 during one symbol. For example, the RDIF block 1404 may generate the read address and the read enable based on the following conditional statement. The algorithm for the RDIF block 1404 may be expressed as follows.

RDIF

```
if (Symbol Sync == 1)
  rd_clkcnt <= 0
  tm_cnt <= 0
else
  if (rd_clkcnt == (SYM_CLKCNT/TM)−1)
    rd_clkcnt <= 0
    tm_cnt <= tm_cnt + 1
  else
    rd_clkcnt <= rd_clkcnt + 1
    tm_cnt <= tm_cnt
if (rd_clkcnt < NFFT)
  RD_ENABLE <= 1
  RD_ADDR <= {~Symbol_CNT[0], tmcnt, rd_clkcnt)
else
  RD_ENABLE <= 0
  RD_ADDR <= 0
```

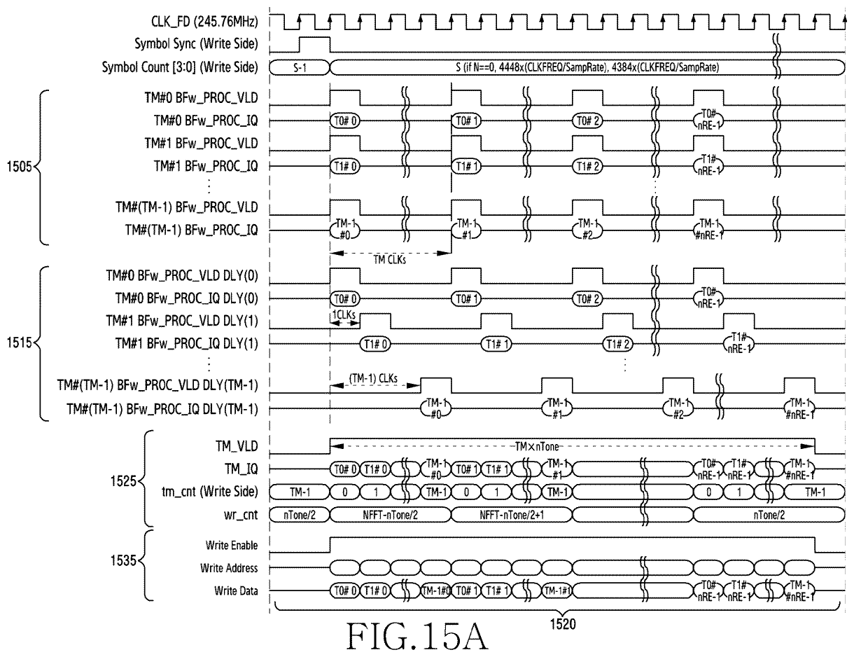

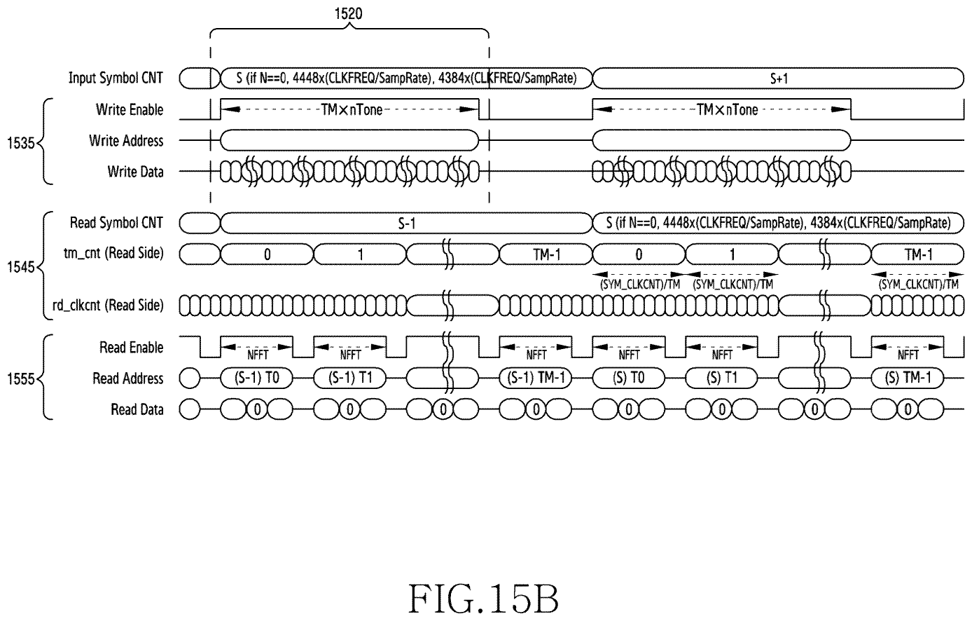

FIGS. 15A and 15B illustrate an example of timing regarding IFFT conversion according to various embodiments of the disclosure. More specifically, signal outputs according to FIGS. 15A and 15B may be the same as an IFFT input format 1045 of the timing diagrams illustrated in FIGS. 10A and 10B.

According to an embodiment, referring to FIGS. 15A and 15B, an example of timing regarding IFFT conversion is illustrated for a case where an SCS is 30 kHz and a 4096-point IFFT is used and a clock frequency operates at 245.76 MHz, that is, in a case of a 2-path MUX.

According to an embodiment, the timing diagram 1520 of FIG. 15A illustrates an example for performing IFFT conversion on multiplexed antenna IQ data TX #0 and TX #1. A second timing diagram of FIG. 15B illustrates, by including the first timing diagram 1520 as a part thereof, an example in which 2-path Multiplexed antenna IQ data signals are processed as IFFT input signals for IFFT processing (for example, IFFT conversion).

Referring to FIG. 15A, according to an embodiment, antenna IQ data signals 1505 to be multiplexed (for example, TX #0 to TX #(TM-1)) may be processed by a beamforming weight processing block and delivered to an IFFT conversion block. In this case, each signal may include tones corresponding to REs at intervals of TM clocks.

According to an embodiment, for multiplexing antenna IQ data, a signal 1515 including tones delayed by n clocks through a DLY(n) block may be acquired. For example, a tone of TX #0 corresponding to each RE and a tone of TX #1 corresponding thereto may differ by one clock, and a tone of TX #0 and a tone of TX #TM-1 may differ by (TM-1) clocks.

According to an embodiment, a multiplexed antenna data signal 1525 may be acquired by summation, and based thereon, a WRIF block may generate signals 1535 according to a write address and a write enable.

Referring to FIG. 15B, the second timing diagram illustrates, from a broader perspective, a timing diagram including two multiplexed antenna data paths (for example, TX #0 and TX #1) per one symbol count, based on the first timing diagram 1520 of FIG. 15A.

According to an embodiment, the second timing diagram may include two antenna IQ data signals (for example, TX #0 and TX #1) during a period of one symbol count S or 5+1. As described above, after one symbol count from a time point at which signals 1535 according to the write address and the write enable are generated, a multiplexed antenna data signal 1545 may be identified for reading, and based thereon, an RDIF block may generate signals 1555 according to a read address and a read enable.

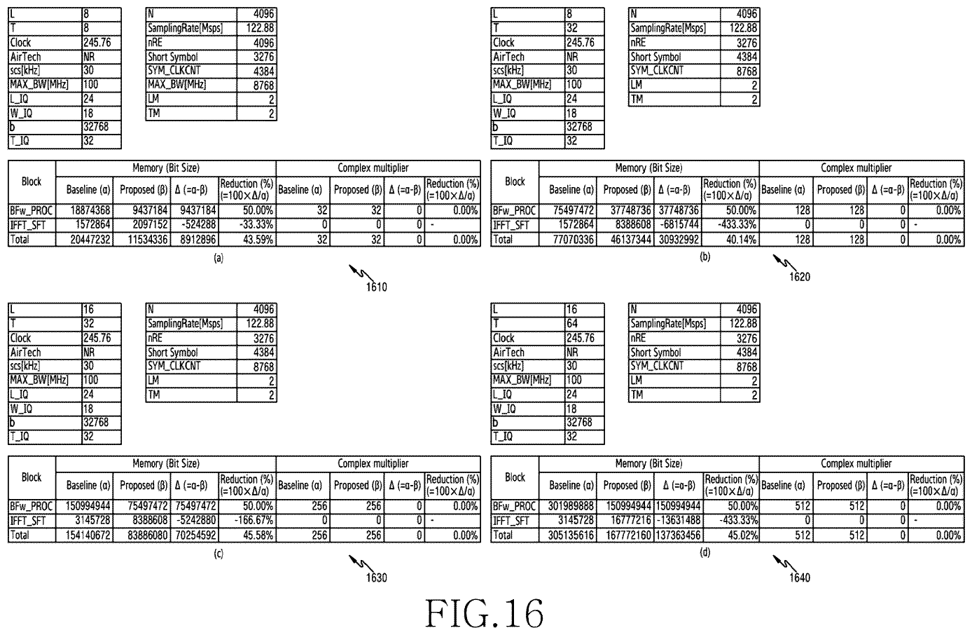

FIG. 16 illustrates examples of improved usage amounts and reduction rates of memory and complex multipliers according to various embodiments of the disclosure.

According to an RU structure including a beamforming block and an IFFT conversion block for performing the above-described layer multiplexing, usage amounts of complex multipliers and memory for beamforming weight processing may be reduced. Such effects may be specifically shown as illustrated in Tables 3 and 4 below.

TABLE 3

| Complex multiplier | Structure in FIG. 9A | Structure in FIG. 11A |
|---|---|---|
| BFw_PROC | L × (T/TM) | (L/LM) × T |

Table 3 illustrates examples of usage amounts of complex multipliers for respective structures. According to an embodiment, in the case of the complex multiplier usage amounts shown in Table 3, LM may be greater than or equal to TM based on the above-described Equations 8 and 9. Accordingly, the usage amount of complex multipliers included in a beamforming weight processing block may be inversely proportional to TM in the case of a structure according to FIG. 9A, or may be inversely proportional to LM in the case of a structure according to FIG. 11A. As a result, compared to the structure according to FIG. 9A, the structure according to FIG. 11A may have the same or reduced usage amount of complex multipliers. According to an embodiment, however, when values of LM and TM are different, an operation clock of an IFFT block may not be a multiple of a power of two, which may increase structural complexity, and accordingly, use of a separate clock for the IFFT block may be required in order to operate the IFFT block at a 2” multiple.

TABLE 4

| Memory | | |
|---|---|---|
| (Bit Size) | Structure in FIG. 9A | Structure in FIG. 11A |
| BFw_PROC | W_IQ × b × T × L/2 | W_IQ × b × T × L/(2 × LM) |
| IFFT_SFT | L_IQ × 2 × N × L | T_IQ × 2 × N × T |

W_IQ: Beamforming weight IQ bitwidth; L_IQ: Downlink (DL) layer data IQ bitwidth;T_IQ: Downlink (DL) antenna data IQ bitwidth;b: Number of possible cases that a beamId may have (for example, 2\hat{ }(beamId bitwidth)=2\hat{ }15=32768);L: Number of layers; T: Number of antennas;SYM_CLKCNT: Normal symbol clock count value;nRE: Number of resource elements (REs);andN: Size of an N-point IFFT.

Table 4 illustrates examples of usage amounts of memories included in beamforming weight processing blocks and memories for IFFT conversion for respective structures. According to an embodiment, in the case of the memory usage amounts shown in Table 4, since L may be less than or equal to T as described above, a usage amount of memory for IFFT conversion may be slightly higher in a structure according to FIG. 11A. However, since a value b that determines a memory usage amount of the beamforming weight processing block is significantly larger than respective factors that determine the memory usage amount for IFFT conversion, a substantially large memory reduction effect may be achieved in the structure according to FIG. 11A as compared to the structure according to FIG. 9A, when considered overall.

Referring to FIG. 16, usage amounts and reduction rates of memories and complex multipliers for respective RU structures according to the structure of FIG. 11A, under a clock frequency environment of 245.76 MHz, for an RU LPHY-DL block supporting NR SCS 30 kHz and a bandwidth of 100 MHz, are illustrated.

A first case 1610 of FIG. 16 illustrates a memory reduction rate of an RU having an 8-layer-8-antenna structure. More specifically, compared to the structure according to FIG. 9A, the structure according to FIG. 11A may have a 33.33% increase in a usage amount of memory for an IFFT conversion block, whereas a usage amount of memory for a beamforming weight processing block may be reduced by approximately 50%, thereby achieving an overall memory usage reduction effect of 43.59%. In contrast, a usage amount of complex multipliers may exhibit no significant change.

A second case 1620 of FIG. 16 illustrates a memory reduction rate of an RU having an 8-layer-32-antenna structure. Compared to the structure according to FIG. 9A, the structure according to FIG. 11A may have a 43.33% increase in a usage amount of memory for the IFFT conversion block, whereas a usage amount of memory for the beamforming weight processing block may be reduced by approximately 50%, thereby achieving an overall memory usage reduction effect of 40.14%. In contrast, a usage amount of complex multipliers may exhibit no significant change.

The second case 1620 of FIG. 16 illustrates a memory reduction rate of an RU having an 8-layer-32-antenna structure. Compared to the structure according to FIG. 9A, the structure according to FIG. 11A may have a 433.33% increase in a usage amount of memory for an IFFT conversion block, whereas a usage amount of memory for a beamforming weight processing block may be reduced by approximately 50%, thereby achieving an overall memory usage reduction effect of 40.14%. In particular, as the number of antennas increases, an absolute bit usage required for the memory of the beamforming weight processing block increases, and thus the above-described result may be obtained. In contrast, a usage amount of complex multipliers may exhibit no significant change.

A third case 1630 of FIG. 16 illustrates a memory reduction rate of an RU having a 16-layer-32-antenna structure. Compared to the structure according to FIG. 9A, the structure according to FIG. 11A may have a 166.67% increase in a usage amount of memory for the IFFT conversion block, whereas a usage amount of memory for the beamforming weight processing block may be reduced by approximately 50%, thereby achieving an overall memory usage reduction effect of 45.58%. In contrast, a usage amount of complex multipliers may exhibit no significant change.

A fourth case 1640 of FIG. 16 illustrates a memory reduction rate of an RU having a 16-layer-64-antenna structure. Compared to the structure according to FIG. 9A, the structure according to FIG. 11A may have a 433.33% increase in a usage amount of memory for an IFFT conversion block, whereas a usage amount of memory for a beamforming weight processing block may be reduced by approximately 50%, thereby achieving an overall memory usage reduction effect of 45.02%. In particular, as the number of antennas increases, an absolute bit usage required for the memory of the beamforming weight processing block increases, and thus the above-described result may be obtained. In contrast, a usage amount of complex multipliers may exhibit no significant change.

According to an embodiment, when the beamforming weight processing block operates at a clock frequency of 368.64 MIz, a system clock count value may be 13,152 clock cycles. In this case, based on the above-described equations, LM may be derived as 4, and accordingly, usage amounts of beam weight memory and complex multipliers may be further reduced. As noted from above, under various environments, memory usage according to various embodiments of the disclosure is reduced.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a radio unit (RU) in a wireless communication system, the method comprising:
acquiring, based on at least one piece of layer data, one or more pieces of multiplexed layer data;
acquiring at least one piece of antenna data by applying beamforming weights to the one or more pieces of multiplexed layer data;
performing an inverse fast Fourier transform (IFFT) conversion on the at least one piece of antenna data; and
performing IFFT processing on the at least one piece of antenna data on which the IFFT conversion has been performed.

2. The method of claim 1, wherein a number of the one or more pieces of multiplexed layer data corresponds to a value obtained by dividing a number of the at least one piece of layer data by a layer multiplexing rate.

3. The method of claim 2, wherein the layer multiplexing rate corresponds to a quotient obtained by dividing a system clock count value of the RU by a number of resource elements (REs) associated with the at least one piece of layer data.

4. The method of claim 1, wherein the acquiring of the at least one piece of antenna data by applying beamforming weights to the one or more pieces of multiplexed layer data comprises:
applying the beamforming weights to the one or more pieces of multiplexed layer data; and
acquiring the at least one piece of antenna data based on accumulation of the one or more pieces of multiplexed layer data to which the beamforming weights have been applied.

5. The method of claim 1, further comprising acquiring one or more pieces of multiplexed antenna data based on the at least one piece of antenna data.

6. The method of claim 5, wherein a number of the one or more pieces of multiplexed antenna data corresponds to a value obtained by dividing a number of the at least one piece of antenna data by an antenna multiplexing rate.

7. The method of claim 6, wherein the antenna multiplexing rate corresponds to a value obtained by dividing a system frequency of the RU by a sample rate associated with the at least one piece of layer data.

8. The method of claim 1, wherein a memory related to the beamforming weights of the RU is a dual-port memory.

9. The method of claim 1, further comprising receiving, from a distributed unit, the at least one piece of layer data to which resource mapping has been applied.

10. The method of claim 1, further comprising inserting a cyclic prefix (CP) into a symbol of the at least one piece of antenna data on which the IFFT processing have been performed.

11. A radio unit (RU) in a wireless communication system, comprising:
a transceiver; and
a controller coupled to the transceiver,
wherein the controller is configured to:
acquire, based on at least one piece of layer data, one or more pieces of multiplexed layer data;
acquire at least one piece of antenna data by applying beamforming weights to the one or more pieces of multiplexed layer data;
perform an IFFT conversion on the at least one piece of antenna data; and
perform IFFT processing on the at least one piece of antenna data on which the IFFT conversion has been performed.

12. The RU of claim 11, wherein a number of the one or more pieces of multiplexed layer data corresponds to a value obtained by dividing a number of the at least one piece of layer data by a layer multiplexing rate.

13. The RU of claim 12, wherein the layer multiplexing rate corresponds to a quotient obtained by dividing a system clock count value of the RU by a number of resource elements (REs) associated with the at least one piece of layer data.

14. The RU of claim 11, wherein, to acquire the at least one piece of antenna data by applying beamforming weights to the one or more pieces of multiplexed layer data, the controller is further configured to:
apply the beamforming weights to the one or more pieces of multiplexed layer data; and
acquire the at least one piece of antenna data based on accumulation of the one or more pieces of multiplexed layer data to which the beamforming weights have been applied.

15. The RU of claim 11, wherein the controller is further configured to acquire one or more pieces of multiplexed antenna data based on the at least one piece of antenna data.

16. The RU of claim 15, wherein a number of the one or more pieces of multiplexed antenna data corresponds to a value obtained by dividing a number of the at least one piece of antenna data by an antenna multiplexing rate.

17. The RU of claim 16, wherein the antenna multiplexing rate corresponds to a value obtained by dividing a system frequency of the RU by a sample rate associated with the at least one piece of layer data.

18. The RU of claim 11, wherein a memory related to the beamforming weights of the RU is a dual-port memory.

19. The RU of claim 11, wherein the controller is further configured to receive, from a distributed unit, the at least one piece of layer data to which resource mapping has been applied.

20. The RU of claim 11, wherein the controller is further configured to insert a cyclic prefix (CP) into a symbol of the at least one piece of antenna data on which the IFFT processing have been performed.
